(19) United States
(12) Patent Application Publication
(10) Pub. No.: US 2023/0379098 A1
(43) Pub. Date: Nov. 23, 2023

(54) TERMINAL, RADIO COMMUNICATION METHOD AND BASE STATION

(71) Applicant: NTT DOCOMO, INC., Tokyo (JP)

(72) Inventors: Shinya Kumagai, Tokyo (JP); Satoshi Nagata, Tokyo (JP); Lan Chen, Beijing (CN); Jing Wang, Beijing (CN); Qiping Pi, Beijing (CN); Jialin Wu, Beijing (CN); Yong Li, Beijing (CN)

(73) Assignee: NTT DOCOMO, INC., Tokyo (JP)

(21) Appl. No.: 18/248,598

(22) PCT Filed: Oct. 13, 2020
(86) PCT No.: PCT/JP2020/038628

§ 371 Date: Apr. 11, 2023

(51) Int. Cl. H04L 1/1829; H04W 72/232; H04W 72/11

(52) U.S. Cl. CPC H04L 1/1854; H04W 72/232; H04W 72/11

(57) ABSTRACT

A terminal according to an aspect of the present disclosure includes: a receiving section configured to receive information regarding skipping of a hybrid automatic repeat request acknowledgement (HARQ-ACK) for a semi-persistent scheduling (SPS) physical downlink shared channel (PDSCH) that is not transmitted; and a control section configured to control HARQ-ACK bundling for a SPS PDSCH that is transmitted, on the basis of information included in downlink control information (DCI). According to one aspect of the present disclosure, it is possible to suitably transmit and receive a semi-persistent scheduling PDSCH and a HARQ-ACK corresponding to the PDSCH.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). Furthermore, the specifications of LTE-Advanced (3GPP Rel. 10 to 14) have been drafted for the purpose of further increasing capacity and advancement of LTE (third generation partnership project (3GPP) release (Rel.) 8 and 9).

Successor systems to LTE (for example, also referred to as 5th generation mobile communication system (5G), 5G+ (plus), 6th generation mobile communication system (6G), New Radio (NR), 3GPP Rel. 15 and subsequent releases, and the like) have also been studied.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

In Rel. 15 and 16 NR, in reception of a downlink (DL) channel (for example, a downlink shared channel (for example, PDSCH)) by semi-persistent scheduling (SPS) by a user terminal (user equipment (UE)), a hybrid automatic repeat request acknowledgement (HARQ-ACK) corresponding to a SPS PDSCH that is not actually transmitted is also transmitted. Therefore, for Rel. 17, from the viewpoint of reducing power consumption of the UE, reducing interference in uplink (UL), and the like, it has been studied to reduce a payload (size) of the HARQ-ACK for the SPS PDSCH.

However, methods of reducing the payload of the HARQ-ACK have not been sufficiently studied. If the methods are not clarified, transmission of the HARQ-ACK having a high payload and frequent uplink transmission (for example, transmission of a physical uplink control channel (PUCCH) and a physical uplink shared channel (PUSCH)) are performed, and as a result of which there is a possibility that reliability of communication deteriorates.

It is therefore an object of the present disclosure to provide a terminal, a radio communication method, and a base station capable of suitably transmitting and receiving an HARQ-ACK corresponding to a PDSCH by semi-persistent scheduling.

### Solution to Problem

A terminal according to an aspect of the present disclosure includes: a receiving section configured to receive information regarding skipping of a hybrid automatic repeat request acknowledgement (HARQ-ACK) for a semi-persistent scheduling (SPS) physical downlink shared channel (PDSCH) that is not transmitted; and a control section configured to control HARQ-ACK bundling for a SPS PDSCH that is transmitted, on the basis of information included in downlink control information (DCI).

### Advantageous Effects of Invention

According to one aspect of the present disclosure, it is possible to suitably transmit and receive a semi-persistent scheduling PDSCH and a HARQ-ACK corresponding to the PDSCH.

### BRIEF DESCRIPTION OF DRAWINGS

FIG. 1 is a diagram illustrating an example of transmission control of a hybrid automatic repeat request acknowledgement (HARQ-ACK) for a semi-persistent scheduling (SPS) physical downlink shared channel (PDSCH).

FIG. 2 is a diagram illustrating another example of the transmission control of the HARQ-ACK for the SPS PDSCH.

FIG. 3 is a diagram illustrating an example of skipping of the SPS PDSCH.

FIGS. 4A and 4B are diagrams illustrating an example of determining the first HARQ-ACK to which bundling according to Embodiment 3-1-1 and Embodiment 3-1-2 is applied.

FIGS. 5A and 5B are diagrams illustrating an example of determining the final HARQ-ACK to which bundling according to Embodiment 3-2-1 and Embodiment 3-2-2 is applied.

FIG. 6 is a diagram illustrating an example of a HARQ-ACK bundling method for one SPS configuration.

FIG. 7 is a diagram illustrating another example of the HARQ-ACK bundling method for one SPS configuration.

FIG. 8 is a diagram illustrating an example of a HARQ-ACK bundling method for a plurality of SPS configurations.

FIG. 9 is a diagram illustrating another example of the HARQ-ACK bundling method for a plurality of SPS configurations.

FIG. 10 is a diagram illustrating an example of a schematic configuration of a radio communication system according to one embodiment.

FIG. 11 is a diagram illustrating an example of a configuration of a base station according to one embodiment.

FIG. 12 is a diagram illustrating an example of a configuration of a user terminal according to one embodiment.

FIG. 13 is a diagram illustrating an example of a hardware configuration of the base station and the user terminal according to one embodiment.

### DESCRIPTION OF EMBODIMENTS

### (Hybrid Automatic Repeat Request Acknowledgement (HARQ-ACK) Codebook)

A user equipment (UE) may transmit a hybrid automatic repeat request acknowledgement (HARQ-ACK) feedback by using one physical uplink control channel (PUCCH) resource for every HARQ-ACK codebook including one or more delivery acknowledgement information (for example, HARQ-ACK) bits. The HARQ-ACK bits may be referred to as HARQ-ACK information, HARQ-ACK information bits, or the like.

Here, the HARQ-ACK codebook may include bits for the HARQ-ACKs in at least one unit of a time domain (for example, a slot), a frequency domain (for example, component carrier (CC)), a spatial domain (for example, a layer), a transport block (TB), and a code block group (CBG) constituting the TB. The HARQ-ACK codebook may be simply referred to as a codebook.

Note that the number (size) of bits included in the HARQ-ACK codebook or the like may be determined in a semi-static or dynamic manner. The HARQ-ACK codebook of which the size is determined semi-statically is also referred to as, for example, a semi-static HARQ-ACK codebook or a type-1 HARQ-ACK codebook. The HARQ-ACK codebook of which the size is determined dynamically is also referred to as, for example, a dynamic HARQ-ACK codebook or a type-2 HARQ-ACK codebook.

Which one of the type-1 HARQ-ACK codebook and the type-2 HARQ-ACK codebook is to be used may be configured in the UE by using a higher layer parameter (for example, pdsch-HARQ-ACK-codebook).

For the type-1 HARQ-ACK codebook, the UE may feed back, in a certain range (for example, a range configured on the basis of the higher layer parameter), the HARQ-ACK bit for a candidate physical downlink shared channel (PDSCH) (or PDSCH occasion) corresponding to the range, regardless of whether or not there is PDSCH scheduling.

The range may be determined on the basis of at least one of a certain period (for example, a set of a specific number of occasions for receiving the candidate PDSCH or a specific number of monitoring occasions of a physical downlink control channel (PDCCH)), the number of CCs configured or activated in the UE, the number of TBs (layer number or rank), the number of CBGs per TB, or whether or not spatial bundling is applied. The specific range is also referred to as a HARQ-ACK window, a HARQ-ACK bundling window, a HARQ-ACK feedback window, and the like.

In the type-1 HARQ-ACK codebook, the UE reserves the HARQ-ACK bit for the PDSCH in the codebook if they are within the specific range even in a case where the PDSCH is not scheduled for the UE. In a case where it is determined that the PDSCH is not actually scheduled, the UE can feed back the bit as a NACK bit.

Meanwhile, in a case of the type-2 HARQ-ACK codebook, the UE may feed back the HARQ-ACK bit for the PDSCH that is scheduled within the specific range.

Specifically, the UE may determine the number of bits of the type-2 HARQ-ACK codebook on the basis of a specific field (for example, a downlink assignment indicator (index) (DAI) field) in the DCI. Note that the DAI field may include a counter DAI (C-DAI) and a total DAI (T-DAI).

The C-DAI may indicate a counter value of downlink transmission (PDSCH, data, and TB) scheduled within a specific period. For example, the C-DAI in the DCI for scheduling data within the specific period may indicate the number counted in the frequency domain (for example, the CC) first and then in the time domain within the specific period. For example, the C-DAI may correspond to a value obtained by counting PDSCH receptions or semi-persistent scheduling (SPS) releases in ascending order of serving cell indices and then in ascending order of PDCCH monitoring occasions regarding one or more pieces of DCI included in the specific period.

The T-DAI may indicate a total value (total number) of pieces of data scheduled within the specific period. For example, the T-DAI in the DCI for scheduling data in a certain time unit (for example, the PDCCH monitoring occasion) within the specific period may indicate the total number of pieces of data scheduled up to the time unit (also referred to as a point, a timing, or the like) within the specific period.

It is also studied that HARQ-ACK codebooks are separately configured for different service types (or PDSCHs or HARQ-ACKs to which different priorities are configured). That is, it is conceivable that a plurality of HARQ-ACK codebooks are simultaneously configured to support a plurality of service types (or a plurality of priorities). For example, a first HARQ-ACK codebook corresponding to ultra reliable and low latency communications (URLLC) (for example, a first priority) and a second HARQ-ACK codebook corresponding to eMBB (for example, a second priority) may be configured.

In this case, a first PUCCH configuration parameter (for example, PUCCH configuration or PUCH configuration parameters) corresponding to the first HARQ-ACK codebook and a second PUCCH configuration parameter corresponding to the second HARQ-ACK codebook may be separately supported or configured. The PUCCH configuration parameter may be at least one of a PUCCH resource (or a PUCCH resource set) applied to transmission of the HARQ-ACK, PUCCH transmission timing (for example, K1 set), a maximum code rate (for example, a max-code rate), or PUCCH transmission power.

In this case, first PUCCH configuration information may be applied to HARQ-ACK feedback for URLLC, and second PUCCH configuration information may be applied to HARQ-ACK feedback for eMBB.

### (HARQ Process)

For a UE in which carrier aggregation (CA) or dual connectivity (DC) is configured, there may be one independent HARQ entity for each cell (CC) or each cell group (CG). The HARQ entity may manage a plurality of HARQ processes in parallel.

In a radio communication system, data transmission is based on scheduling, and scheduling information for downlink (DL) data transmission is carried in downlink control information (DCI). A HARQ process number (HPN) is given to a HARQ process. The DCI includes a 4-bit HARQ process number field indicating the HARQ process number used for the current data transmission. The HARQ entity manages a plurality (up to 16) of HARQ processes in parallel. That is, the HARQ process numbers include HPNO to HPN15. The HARQ process number is also referred to as a HARQ process identifier (HARQ process ID).

A unit of transmitting uplink (UL) data by a physical uplink shared channel (PUSCH) and a unit of transmitting DL data by a physical downlink shared channel (PDSCH) may be referred to as a transport block (TB). The TB is a unit handled by a media access control (MAC) layer. The control of HARQ (retransmission) may be performed for each TB or may be performed for each code block group (CBG) including one or more code blocks (CBs) in a TB.

The UE transmits information indicating positive acknowledgement response (ACK)/negative acknowledgement response (NACK) of HARQ, which indicates whether or not decoding of a DL transport block having received using the PDSCH is successful, to a base station using a physical uplink control channel (PUCCH), a PUSCH, or the like.

In a case where a plurality of pieces of UL data or a plurality of pieces of DL data are not spatially multiplexed in a physical layer, a single HARQ process corresponds to one transport block (TB). In a case where a plurality of pieces of UL data or a plurality of pieces of DL data are spatially multiplexed in the physical layer, a single HARQ process may correspond to one or more transport blocks (TBs).

### (Semi-Persistent Scheduling)

In NR, semi-persistent scheduling (SPS) configured by higher layer signaling (for example, RRC signaling) is supported. The SPS may be configured for each serving cell, for each bandwidth part (BWP), or for each carrier. For example, activation/deactivation of DL SPS may be separately controlled between cells, between BWPs, or between carriers.

In the present disclosure, the higher layer signaling may be any of, for example, radio resource control (RRC) signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

The physical layer signaling may be, for example, downlink control information (DCI).

The DL SPS may be applied to a physical downlink shared channel (PDSCH). In this case, activation/deactivation of the PDSCH may be instructed by a physical downlink control channel (PDCCH)) (or DCI). The deactivation may be read as release. In a case where the activation of the DL SPS is instructed by the PDCCH, the UE may control reception operation of the semi-persistent PDSCH whose transmission/allocation is controlled using a specific transmission condition. The reception operation may be read as monitoring, decoding processing, or demodulation processing of a PDCCH (or DCI).

The transmission condition/transmission parameter to be applied to the semi-persistent PDSCH may be configured by higher layer signaling/physical layer signaling. The parameter to be applied to the semi-persistent PDSCH may be referred to as SPS configuration information.

In the NR Rel. 16, the SPS configuration information (for example, SPS-Config) notified by the higher layer signaling may include at least one of the following:
information indicating a periodicity (for example, periodicity);
information indicating the number of HARQ processes (for example, nrofHARQ-Processes);
information (for example, n1PUCCH-AN) related to a resource (for example, a PUCCH resource) for an uplink control channel (for example, physical uplink control channel) to be used for transmission of an HARQ-ACK;
table information (for example, the MCS table (mcs-Table)) to be used for determining a modulation and coding scheme (MCS);
information (for example, a SPS configuration index, sps-ConfigIndex, and sps-ConfigIndex-r16) indicating one of a plurality of DL SPS configurations in one BWP;
information related to an offset to be used to generate the HARQ process ID (for example, harq-ProcID-Offset and harq-ProcID-Offset-r16);
information for calculating a periodicity of the SPS PDSCH (for example, periodicityExt and periodicityExt-r16);
information (for example, harq-CodebookID and harq-CodebookID-r16) indicating an HARQ-ACK codebook corresponding to an HARQ-ACK for the SPS PDSCH and an ACK for SPS PDSCH release; and
Information indicating the number of repetitions of the SPS PDSCH (for example, pdsch-AggregationFactor and pdsch-AggregationFactor-r16).

At least one of the SPS activation DCI and the release DCI may include at least one piece of the following information.
Information (time domain resource assignment (TDRA)) regarding the allocation of time domain resources (for example, one or more symbols)
Information (frequency domain resource assignment (FDRA)) regarding the allocation of frequency domain resources (for example, one or more physical resource blocks (PRB) (also referred to as resource blocks (RB))
Information regarding the MCS (for example, an MCS index)
Information (for example, a HARQ process number (HPN) and a HARQ process ID) indicating the HARQ process
Information (for example, redundancy version (RV)) indicating a redundancy version
Information (for example, a downlink assignment index (DL assignment index)) regarding the DL assignment
Information (for example, a PUCCH resource indicator) regarding the PUCCH resource
Information (for example, a PDSCH-HARQ-ACK feedback timing indicator (PDSCH-to-HARQ feedback timing indicator)) regarding a timing to feed back (transmit) the HARQ-ACK
Information (for example, a carrier indicator (CI)) regarding a carrier
Information (for example, a bandwidth part indicator (BI)) regarding a bandwidth part (BWP)
New data indicator (NDI)

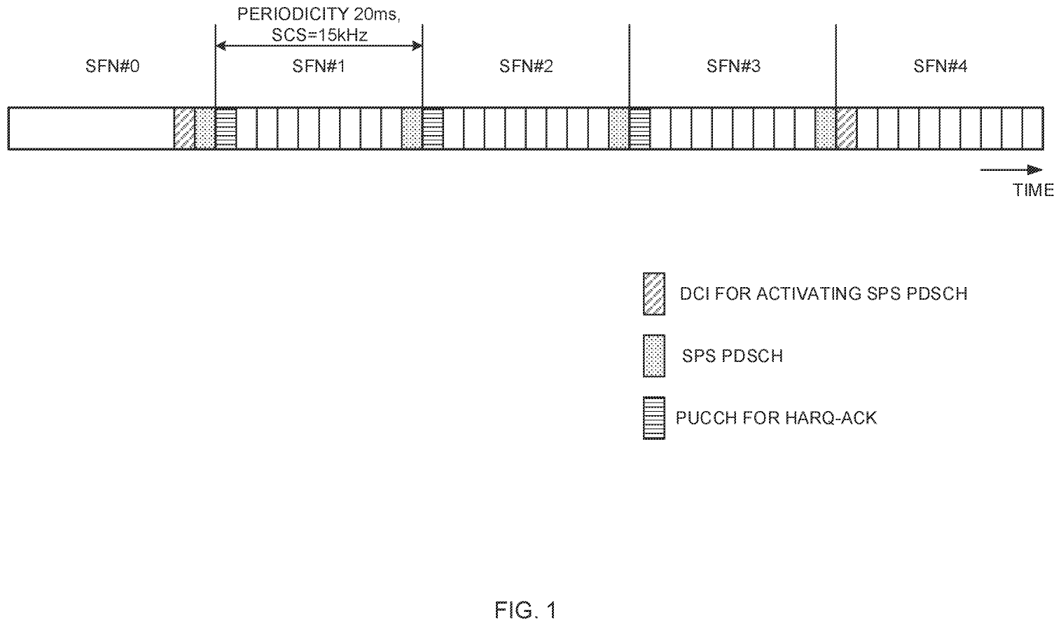

FIG. 1 illustrates an example of a case where a semi-persistent PDSCH (SPS PDSCH) is transmitted. Here, a case where a periodicity is set to 20 ms and an applied subcarrier spacing is set to 15 kHz is illustrated, but the transmission condition of the PDSCH is not limited thereto.

In FIG. 1, the network gives an instruction to activate the SPS PDSCH by using DCI. The DCI indicating activation of the SPS PDSCH may be, for example, a DCI format 1_0/1_1/1_2. Once the DCI is detected, the UE performs SPS PDSCH reception processing assuming (or expecting) that the SPS PDSCH is transmitted with a specific periodicity.

The UE may feed back the HARQ-ACK for the SPS PDSCH. For example, the UE may transmit the HARQ-ACK for the SPS PDSCH by using the PUCCH. The UE may be notified of conditions such as a transmission timing of the HARQ-ACK (or PUCCH) (for example, K0) using the DCI indicating activation of the SPS PDSCH. Alternatively, conditions such as a transmission timing of the HARQ-ACK (or PUCCH) (for example, K0) may be configured by higher layer signaling (for example, dl-DataToUL-ACK).

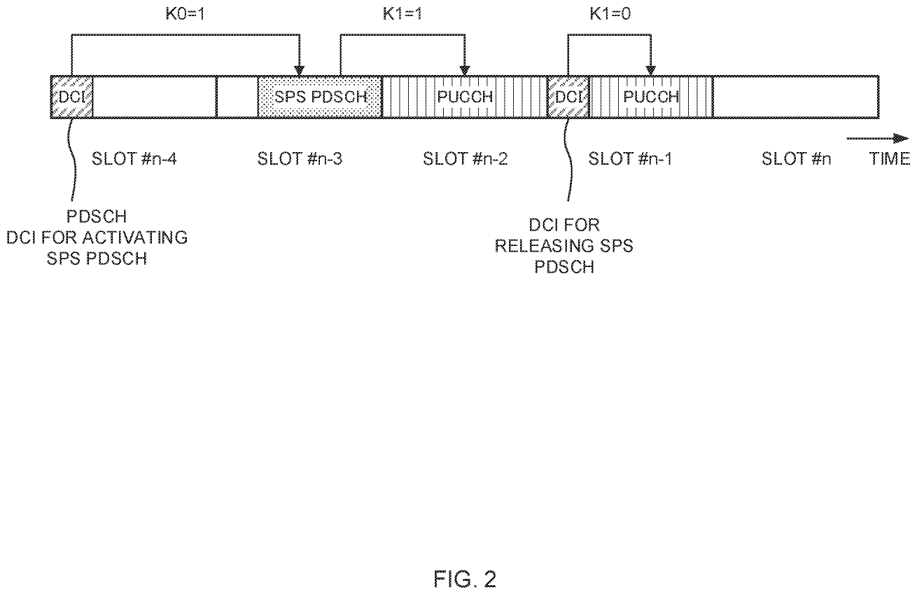

In a case where DCI indicating deactivation of the SPS PDSCH is received, the UE may control not to perform the SPS PDSCH reception processing. The UE may feed back the HARQ-ACK for the DCI indicating deactivation of the SPS PDSCH. For example, the UE may transmit the HARQ-ACK for the DCI by using the PUCCH. The UE may be notified of conditions such as a transmission timing of the HARQ-ACK (or the PUCCH) (for example, K1) using the DCI indicating deactivation of the SPS PDSCH (see FIG. 2).

By the way, even in a case where the reception of the SPS PDSCH is configured for the UE, traffic of the SPS PDSCH does not actually exist in some cases. In NR prior to Rel. 16, the UE feeds back the HARQ-ACK (ACK/NACK) for each transmission occasion of the SPS PDSCH regardless of the actual presence or absence of traffic.

On the other hand, in Rel. 16, a plurality of SPS configurations and a shorter periodicity of the SPS transmission occasion can be configured. Therefore, in Rel. 17 and subsequent releases, from the viewpoint of reducing power consumption of/resources used by the UE, avoiding interference in uplink, and the like, it has been studied to reduce a payload of the HARQ-ACK corresponding to the SPS PDSCH. For example, as a method of reducing the payload of the HARQ-ACK, omission (skipping) of transmission of the HARQ-ACK for a specific SPS PDSCH (for example, a SPS PDSCH that is not actually transmitted).

However, a method of reducing the payload of the HARQ-ACK corresponding to the SPS PDSCH has not been sufficiently studied. More specifically, a method of bundling a plurality of HARQ-ACKs when bundling (HARQ bundling) is applied to a plurality of HARQ-ACKs corresponding to the SPS PDSCH has not been sufficiently studied. If the methods are not clarified, transmission of the HARQ-ACK having a high payload and frequent uplink transmission (for example, transmission of a physical uplink control channel (PUCCH) and a physical uplink shared channel (PUSCH)) are performed, and as a result of which there is a possibility that reliability of communication deteriorates.

The present inventors therefore have conceived of a method for suitably transmitting and receiving a semi-persistent scheduling PDSCH and a HARQ-ACK corresponding to the PDSCH.

Hereinafter, embodiments according to the present disclosure will be described in detail with reference to the drawings. The radio communication method according to each of the embodiments may be applied independently, or may be applied in combination with others.

Note that, in the present disclosure, “A/B” may indicate “at least one of A or B”. In the present disclosure, “A/B/C” may indicate at least one of A, B, or C.

Note that, in the present disclosure, a PDSCH by SPS may be read as a SPS PDSCH, configuration grant-based transmission, DL transmission with a configuration grant, configuration scheduling, SPS transmission, a PDSCH, or the like. A specific occasion having a specific periodicity to be used for reception of a SPS PDSCH by the UE or transmission by the base station may be read as a SPS occasion, a DL SPS occasion, a reception occasion, a reception period, a SPS transmission occasion, a transmission occasion, a specific period, a specific timing, a period, or the like.

Note that, in the present disclosure, a SPS PDSCH that is not actually transmitted may be referred to as a SPS PDSCH with no traffic, a SPS PDSCH whose transmission is skipped, a skipped SPS PDSCH, a SPS PDSCH without requiring a HARQ-ACK feedback, or the like.

Furthermore, in the present disclosure, a SPS PDSCH that is actually transmitted may be referred to as a SPS PDSCH with traffic, a SPS PDSCH whose transmission is not skipped, a non-skipped SPS PDSCH, a SPS PDSCH requiring a HARQ-ACK feedback, or simply a SPS PDSCH.

Furthermore, in the present disclosure, a HARQ-ACK for a SPS PDSCH may be referred to as a SPS HARQ-ACK. Furthermore, a skipped HARQ-ACK for a skipped SPS PDSCH may be referred to as a skipped SPS HARQ-ACK or a skipped HARQ-ACK.

Furthermore, in the present disclosure, DCI indicating skipping of the SPS PDSCH/SPS HARQ-ACK may be referred to as DCI indicating skipping or skipping indication DCI.

In the present disclosure, skipping may be replaced with omission, interruption, cancellation, drop, or the like.

Furthermore, in the present disclosure, bundling of a plurality of HARQ-ACKs for a SPS PDSCH may be replaced with SPS HARQ-ACK bundling, SPS HARQ bundling, simply HARQ bundling, or the like.

### (Radio Communication Method)

Hereinafter, in embodiments of the present disclosure, the UE may skip a HARQ-ACK for a skipped SPS PDSCH. The UE may be instructed to perform/notified of the skipping of the SPS PDSCH/SPS HARQ-ACK using DCI/MAC CE.

Further, DCI/MAC CE indicating a skipped SPS PDSCH may be DCI/MAC CE indicating a skipped HARQ-ACK. In addition, the DCI/MAC CE indicating a skipped SPS PDSCH does not have to be the DCI/MAC CE indicating a skipped HARQ-ACK.

Further, in each embodiment of the present disclosure, reporting/indicating skipping of a SPS PDSCH may mean reporting/indicating a skip pattern (skipping pattern) of the SPS PDSCH. In addition, reporting/indicating skipping of a SPS HARQ-ACK may mean reporting/indicating a skipping pattern of the SPS HARQ-ACK.

Furthermore, an embodiment of the present disclosure may be applied to a case where a higher layer parameter that enables DCI/MAC CE indicating skipping of a SPS HARQ-ACK is configured for the UE. In this case, a situation in which a pattern of skipping (skipping pattern) for a certain set of SPS transmission occasions is reported by the DCI/MAC CE indicating skipping of a SPS HARQ-ACK may be assumed.

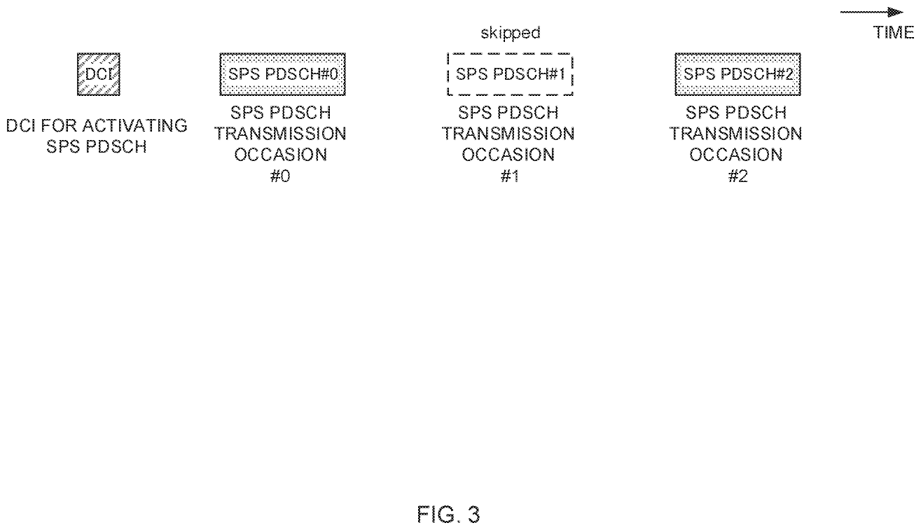

FIG. 3 is a view illustrating an example of skipping of a SPS PDSCH. In the example of FIG. 3, the UE receives DCI for activating a SPS PDSCH. Then, the UE receives a SPS PDSCH in a transmission occasion (here, SPS PDSCH transmission occasions #0 to #2) configured with a specific periodicity.

In the example of FIG. 3, there is actual traffic of a SPS PDSCH #0 and a SPS PDSCH #2 in the transmission occasion #0 and the transmission occasion #2. On the other hand, there is no actual traffic of a SPS PDSCH #1 in the transmission occasion #1. In this case, the network notifies the UE that the SPS PDSCH has been skipped by using specific DCI.

### First Embodiment

In a first embodiment, activation of SPS HARQ bundling for the UE will be described. It may be assumed that the UE performs activation of SPS HARQ bundling according to at least one of the following Embodiments 1-1 to 1-3 on the basis of specific DCI.

### Embodiment 1-1

The UE may apply skipping of HARQ-ACK transmission for a skipped SPS PDSCH.

### Embodiment 1-2

The UE may be triggered to perform/instructed to perform/notified of SPS HARQ-ACK bundling on the basis of Embodiment 1-2-1 and Embodiment 1-2-2 described below.

The UE may be triggered to perform the SPS HARQ-ACK bundling on the basis of specific DCI (Embodiment 1-2-1).

The specific DCI may be, for example, a specific DCI format (for example, a DCI format 1_0/1_1/1_2/0_0/0_1/0_2) defined in Rel. 15 or 16. In addition, the specific DCI may be a DCI format for scheduling an arbitrary PDSCH or a DCI format for activating/releasing a SPS PDSCH. In addition, the specific DCI may be UE specific DCI or group common/UE common DCI.

The specific DCI format may include a field for reporting/indicating SPS HARQ-ACK bundling.

Note that, in a case where the specific DCI is group common/UE common DCI, a field for reporting/indicating SPS

HARQ-ACK bundling for a plurality of UEs may be included in the specific DCI format. In addition, a bit position indicating SPS HARQ-ACK bundling for each UE may be configured by higher layer signaling. The group may mean a PDSCH group.

In addition, the specific DCI format may be scrambled by a specific radio network temporary identifier (RNTI) used for indicating SPS HARQ-ACK bundling.

In addition, the UE may determine that the existing field (for example, as defined in Rel. 15 or 16) included in the specific DCI format is a field indicating SPS HARQ-ACK bundling. At this time, in order to specify whether or not the DCI format is DCI indicating SPS HARQ-ACK bundling, one or more specific fields included in the DCI may be set to a specific value (a combination of specific values).

For example, the specific field may be at least one of a field of information indicating a HARQ process (for example, HPN), a field of information indicating a redundancy version (for example, RV), a field of information regarding an MCS (for example, MCS index), a field of information regarding time domain resource allocation (for example, TDRA), or a field of information regarding frequency domain resource allocation (for example, FDRA). Furthermore, the specific value may be, for example, 1 (or 0).

Further, the specific DCI may be a DCI format newly defined in Rel. 17 and subsequent releases. The DCI format may be represented by, for example, a DCI format X_Y (where X and Y are arbitrary integers or symbols (for example, X=1 and Y=3)). The specific DCI may be UE specific DCI or group common/UE common DCI.

Furthermore, SPS HARQ-ACK bundling may be configured in a SPS configuration, and the UE may be triggered to perform the SPS HARQ-ACK bundling at at least one of a timing when the SPS configuration is activated or a timing when the SPS configuration is enabled by higher layer signaling (RRC signaling) (Embodiment 1-2-2).

### Embodiment 1-3

The UE may perform SPS HARQ-ACK bundling when the following specific condition is met. The specific condition may be defined in advance in a specification, or may be set by higher layer signaling (RRC signaling). The specific condition may be continuous transmission of at least one of a specific number of ACKs or a specific number of NACKs.

The specific condition is considered when the UE determines whether or not to start SPS HARQ-ACK bundling a specific number of times (for example, once), and in a case where the specific condition is satisfied, the specific condition does not have to be considered thereafter.

Further, the specific condition may always be considered when a HARQ-ACK codebook is generated in the UE.

When the specific condition is considered in the UE, the network (NW, for example, a base station (gNB)) may configure/indicate a resource (for example, PUCCH/PUSCH) on which the SPS HARQ-ACK is to be transmitted separately for a case where SPS HARQ-ACK bundling is applied and a case where SPS HARQ-ACK bundling is not applied.

In addition, when the specific condition is considered in the UE, the NW may perform SPS HARQ-ACK detection separately for a case where SPS HARQ-ACK bundling is applied and a case where SPS HARQ-ACK bundling is not applied (blind detection).

According to the first embodiment as described above, it is possible to appropriately instruct SPS HARQ-ACK bundling.

### Second Embodiment

In the second embodiment, a period in which SPS HARQ-ACK bundling is applied will be described. It may be assumed that the UE applies SPS HARQ-ACK bundling in a period described in at least one of Embodiment 2-1 or Embodiment 2-2.

### Embodiment 2-1

It may be assumed that, when SPS HARQ-ACK bundling is triggered using the DCI, the UE applies the SPS HARQ-ACK bundling until a certain number (for example, one) of HARQ-ACK codebooks are generated (Embodiment 2-1-1).

The specific number may be defined in advance in a specification or may be set in the UE by higher layer signaling.

In addition, it may be assumed that, when SPS HARQ-ACK bundling is triggered using the DCI, the UE applies the SPS HARQ-ACK bundling for a specific period (Embodiment 2-1-2).

In Embodiment 2-1-2, it may be assumed that the UE applies SPS HARQ-ACK bundling in at least one of a period until another DCI indicating release of the SPS HARQ-ACK bundling is received or a period until an already configured SPS configuration is released. The DCI indicating the release may reuse the DCI for activating the bundling by changing values of one or more specific fields.

Furthermore, in Embodiment 2-1-2, it may be assumed that the UE applies the bundling in a period based on at least one of higher layer signaling (for example, RRC signaling), physical layer signaling (for example, DCI), or a period (for example, referred to as a time window) specified in a specification in advance.

### Embodiment 2-2

It may be assumed that, in a case where SPS HARQ-ACK bundling is configured in a SPS configuration, and the SPS HARQ-ACK bundling is triggered at at least one of a timing when the SPS configuration is activated or a timing when the SPS configuration is enabled by higher layer signaling (RRC signaling), the UE applies the bundling in a period until the SPS configuration is released (Embodiment 2-2-1).

Furthermore, it may be assumed that, in a case where SPS HARQ-ACK bundling is configured in a SPS configuration, and the SPS HARQ-ACK bundling is triggered at at least one of a timing when the SPS configuration is activated or a timing when the SPS configuration is enabled by higher layer signaling (RRC signaling), the UE applies the bundling in a period based on at least one of higher layer signaling (for example, RRC signaling) or a period (for example, a time window) specified in advance in a specification (Embodiment 2-2-2).

As described above, according to the second embodiment, the application timing/period for SPS HARQ-ACK bundling can be appropriately determined.

### Third Embodiment

In a third embodiment, a method of determining the first/last HARQ-ACK codebook to which SPS HARQ-ACK bundling is to be applied will be described. The third embodiment is roughly divided into Embodiment 3-1 and Embodiment 3-2.

### Embodiment 3-1

The UE may determine the first HARQ-ACK codebook to which SPS HARQ-ACK bundling is to be applied on the basis of specific DCI.

For example, the UE may apply SPS HARQ-ACK bundling from a HARQ-ACK codebook after a certain period (also referred to as a gap) or more elapses from reception of the DCI for activating the SPS HARQ-ACK bundling (Embodiment 3-1-1).

Further, the UE may also transmit a HARQ-ACK for the DCI for activating the SPS HARQ-ACK bundling. At this time, the UE may apply the bundling from a HARQ-ACK codebook after a specific period (also referred to as a gap) or more elapses from transmission of the HARQ-ACK for the DCI for activating the SPS HARQ-ACK bundling (Embodiment 3-1-2).

Note that the specific period in Embodiments 3-1-1 and 3-1-2 may be a period (for example, T_{proc,2}) defined in Rel. 15 and 16, or may be a period (for example, K3) defined in a configuration or specification by higher layer signaling. The period (for example, K₃) defined in a configuration or specification by higher layer signaling may be indicated by an offset represented by a specific time unit (for example, slot/sub-slot/symbol).

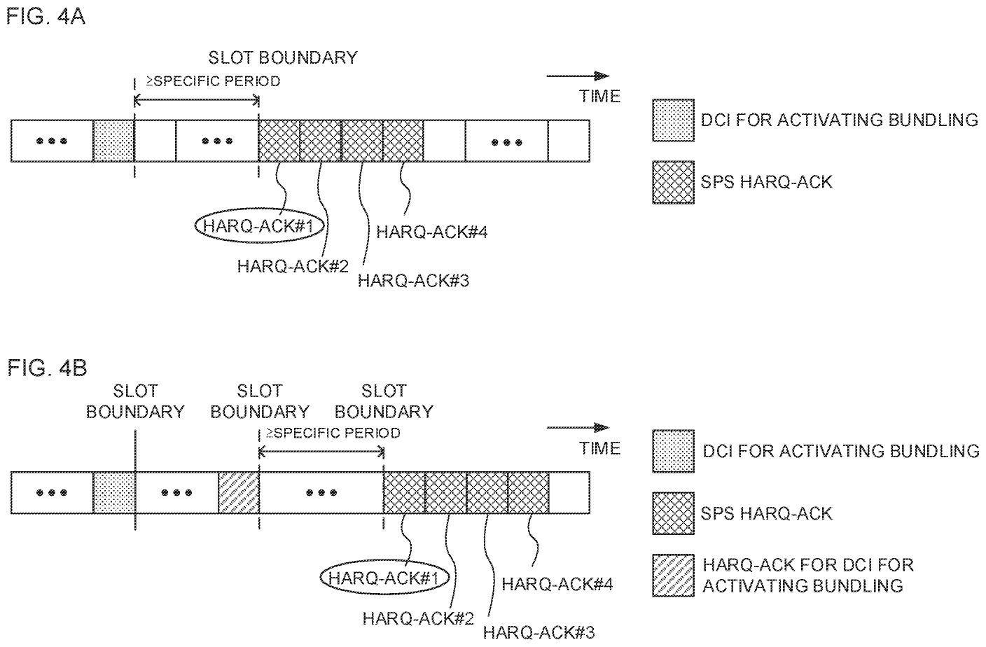

FIG. 4A is a diagram illustrating an example of determining the first HARQ-ACK to which the bundling according to Embodiment 3-1-1 is to be applied. In FIG. 4A, the UE receives the DCI for activating SPS HARQ-ACK bundling. Then, the UE transmits HARQ-ACKs #1 to #4 as HARQ-ACKs for the SPS PDSCH.

In the example illustrated in FIG. 4A, the UE determines HARQ-ACK #1, which is the first SPS HARQ-ACK after a specific period or more elapses from reception of the DCI, as the first HARQ-ACK to which the bundling is to be applied. In the example illustrated in FIG. 4A, the UE applies the bundling to at least HARQ-ACKs #1 to #4.

FIG. 4B is a diagram illustrating an example of determining the first HARQ-ACK to which the bundling according to Embodiment 3-1-2 is to be applied. In FIG. 4B, the UE receives the DCI for activating SPS HARQ-ACK bundling. Then, the UE transmits a HARQ-ACK for the DCI. Further, the UE transmits HARQ-ACKs #1 to #4 as HARQ-ACKs for the SPS PDSCH.

In the example illustrated in FIG. 4B, the UE determines HARQ-ACK #1, which is the first SPS HARQ-ACK after a specific period or more elapses from transmission of the HARQ-ACK for the DCI, as the first HARQ-ACK to which the bundling is to be applied. In the example illustrated in FIG. 4B, the UE applies the bundling to at least HARQ-ACKs #1 to #4.

### Embodiment 3-2

The UE may determine the last HARQ-ACK codebook to which SPS HARQ-ACK bundling is to be applied on the basis of specific DCI.

For example, the UE may apply SPS HARQ-ACK bundling from the start of reception of the DCI for releasing the SPS HARQ-ACK bundling to a HARQ-ACK codebook before a certain period (also referred to as a gap) or more (Embodiment 3-2-1).

The UE may also transmit a HARQ-ACK for the DCI for releasing the SPS HARQ-ACK bundling. At this time, the UE may apply the bundling from a HARQ-ACK codebook before a specific period (also referred to as a gap) or more from the start of transmission of the HARQ-ACK for the DCI for releasing the SPS HARQ-ACK bundling (Embodiment 3-2-2).

Note that the specific period in Embodiments 3-2-1 and 3-2-2 may be a period (for example, T_{proc,2}) defined in Rel. 15 and 16, or may be a period (for example, K₃) defined in a configuration or specification by higher layer signaling. The period (for example, K₃) defined in a configuration or specification by higher layer signaling may be indicated by an offset represented by a specific time unit (for example, slot/sub-slot/symbol).

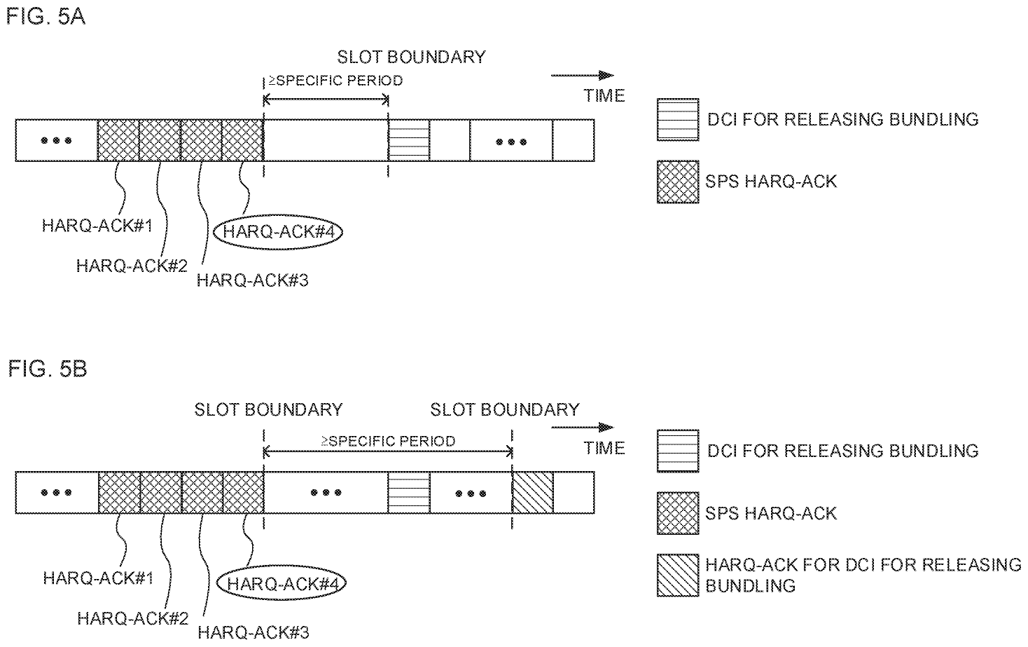

FIG. 5A is a diagram illustrating an example of determining the last HARQ-ACK to which the bundling according to Embodiment 3-2-1 is to be applied. In FIG. 5A, the UE transmits HARQ-ACKs #1 to #4 as HARQ-ACKs for the SPS PDSCH. The UE receives the DCI for releasing SPS HARQ-ACK bundling.

In the example illustrated in FIG. 5A, the UE determines HARQ-ACK #4, which is the last SPS HARQ-ACK before a specific period or more from the start of the DCI, as the last HARQ-ACK to which the bundling is to be applied. In the example illustrated in FIG. 5A, the UE bundles at least the HARQ-ACKs #1 to #4.

FIG. 5B is a diagram illustrating an example of determining the last HARQ-ACK to which the bundling according to Embodiment 3-2-2 is to be applied. In FIG. 5B, the UE transmits HARQ-ACKs #1 to #4 as HARQ-ACKs for the SPS PDSCH. The UE receives the DCI for releasing SPS HARQ-ACK bundling. Further, the UE transmits a HARQ-ACK for the DCI.

In the example illustrated in FIG. 5B, the UE determines HARQ-ACK #4, which is the last SPS HARQ-ACK before a specific period or more from the start of transmission of the HARQ-ACK for the DCI, as the last HARQ-ACK to which the bundling is to be applied. In the example illustrated in FIG. 5B, the UE bundles at least the HARQ-ACKs #1 to #4.

According to the third embodiment above, the first/last HARQ-ACK codebook to which SPS HARQ-ACK bundling is to be applied can be appropriately determined.

### Fourth Embodiment

In a fourth embodiment, a SPS configuration in which SPS HARQ-ACK bundling is applied will be described. Note that, in the present disclosure, the SPS configuration in which the bundling is applied may be SPS activated by higher layer signaling/physical layer signaling.

### Embodiment 4-1

The UE may assume that SPS HARQ-ACK bundling is applied for one SPS configuration.

For example, the UE may be instructed by DCI to configure a SPS configuration (also referred to as a target SPS configuration) in which SPS HARQ-ACK bundling is to be applied (Embodiment 4-1-1). The DCI may include information regarding the target SPS configuration (for example, information indicating a SPS configuration index). The information regarding the target SPS configuration may be a specific field newly defined in Rel. 17 or subsequent releases, or an existing field defined in Rel. 15/16.

Further, after SPS HARQ-ACK bundling is activated, the UE may apply the SPS HARQ-ACK bundling to a SPS configuration corresponding to a specific (for example, the first) SPS transmission occasion (Embodiment 4-1-2). In Embodiment 4-1-2, the UE does not have to explicitly receive the information regarding the target SPS configuration via the DCI.

### Embodiment 4-2

The UE may assume that SPS HARQ-ACK bundling is applied for a plurality of SPS configurations.

The UE may be instructed by DCI to configure a plurality of target SPS configurations (Embodiment 4-2-1).

In Embodiment 4-2-1, the UE may receive a correspondence (table) indicating a combination of one or more SPS configurations for each index (row index) by higher layer signaling (for example, RRC signaling). Next, the UE may determine one or more target SPS configurations on the basis of information regarding the index included in the DCI.

Furthermore, in Embodiment 4-2-1, when the index indicates a plurality of SPS configurations, the UE may apply SPS HARQ-ACK bundling to an active SPS configuration.

The UE may also apply SPS HARQ-ACK bundling to a plurality of (for example, all) active SPS configurations without explicit indication by the DCI (Embodiment 4-2-2).

According to the fourth embodiment described above, the SPS configuration in which SPS HARQ-ACK bundling is to be applied can be appropriately determined.

### Fifth Embodiment

In a fifth embodiment, a SPS HARQ-ACK bundling unit (bundling size) will be described.

When bundling a plurality of HARQ-ACKs, in a case where at least one of the plurality of HARQ-ACKs is a first value (for example, 0), the UE may generate the first value as a HARQ-ACK codebook after bundling, and in a case where all values of the plurality of HARQ-ACKs are a second value (for example, 1), the UE may generate the second value as a HARQ-ACK codebook after bundling (that is, the UE may perform the bundling by using an AND operation).

In a case where there are a plurality of HARQ-ACK codebooks after bundling, the UE may transmit the plurality of HARQ-ACKs after bundling.

### Embodiment 5-1

The UE may bundle HARQ-ACK codebooks every specific number (for example, N (N is a natural number)) to generate a 1-bit HARQ-ACK codebook.

N may be indicated by DCI, may be set by higher layer signaling (RRC signaling), or may be specified in a specification in advance.

In Embodiment 5-1, the number of HARQ-ACK codebooks that are bundled last may be less than N. For example, the total number of bits of HARQ-ACK codebooks before bundling is applied is K, and the number of bits in a bundling unit is N. Here, in a case where mod(K,N)≠0, the last mod(K,N) HARQ-ACK codebooks may be bundled and generated as a 1-bit HARQ-ACK codebook.

In the present disclosure, mod(X,Y) may indicate the remainder obtained by dividing X by Y.

### Embodiment 5-2

The UE may bundle a plurality of HARQ-ACK codebooks in such a way that the number of HARQ-ACK codebooks after bundling is a specific number (for example, K₁ (K₁ is a natural number)).

K₁ may be indicated by DCI, may be set by higher layer signaling (RRC signaling), or may be specified in a specification in advance.

For example, the total number of bits of HARQ-ACK codebooks before bundling is applied is K, and the number of bits in a bundling unit is K₁. Here, in a case where mod(K,K₁)=0, the number of bits as the bundling unit is K/K₁ (K/K₁ means the quotient obtained by dividing K by K₁).

Further, in a case where mod(K,K₁)≠0, the first (former) mod(K,K₁) bits after bundling may be bits bundled for every floor(K/K₁)+1 bits, and the (later) K₁-mod(K,K₁) bits after bundling may be bits bundled for every floor(K/K₁) bits.

Further, in a case where mod(K,K₁)≠0, the first K₁-mod(K,K₁) bits after bundling may be bits bundled for every floor(K/K₁) bits, and mod(K,K₁) bits after bundling may be bits bundled for every floor(K/K₁)+1 bits.

In the present disclosure, floor(X) may represent an integer part of X.

As described above, according to the fifth embodiment, the number of bits as the SPS HARQ-ACK bundling unit can be appropriately determined.

### Sixth Embodiment

In a sixth embodiment, a UE operation related to SPS HARQ-ACK bundling, specifically, a HARQ-ACK codebook bundling/generation method of the UE will be described.

### Embodiment 6-1

In Embodiment 6-1, a HARQ-ACK codebook bundling/generation method of the UE in a case where SPS HARQ-ACK bundling is triggered/activated for one SPS configuration will be described.

The UE may bundle bits of HARQ-ACKs every specific number (for example, N) (step 1). At this time, N may be determined by the method described in the fifth embodiment. Further, at this time, the bits of the HARQ-ACKs corresponding to a SPS transmission occasion may be bundled in a time series of SPS transmission occasions configured in the UE (that is, in ascending order from a HARQ-ACK corresponding to an earlier SPS transmission occasion).

Then, the UE may transmit a HARQ-ACK codebook after bundling to the NW (step 2). Note that, in the present disclosure, for a resource (for example, a PUCCH resource) for transmitting a SPS HARQ-ACK corresponding to each SPS transmission occasion, the UE may be notified of at least one of a resource in a case where bundling is not applied or a resource in a case where bundling is applied by higher layer signaling/physical layer signaling. In addition, for the UE, the resource may be configured in common for a plurality of SPS configurations or may be configured independently for each SPS configuration.

In step 2, the bits of the HARQ-ACKs corresponding to each of the SPS configuration in which bundling is not applied and the SPS configuration in which bundling is applied may be ordered in the same HARQ-ACK codebook in ascending order of information regarding the SPS configuration (for example, the SPS configuration index).

Further, in step 2, the bits of the HARQ-ACKs corresponding to the SPS configuration in which bundling is not applied may be arranged first in ascending order of the information regarding the SPS configuration (for example, the SPS configuration index), and then the bits of the HARQ-ACKs corresponding to the SPS configuration in which bundling is applied may be added.

Alternatively, in step 2, the bits of the HARQ-ACKs corresponding to the SPS configuration in which bundling is applied may be arranged first in ascending order of the information regarding the SPS configuration (for example, the SPS configuration index), and then the bits of the HARQ-ACKs corresponding to the SPS configuration in which bundling is not applied may be added.

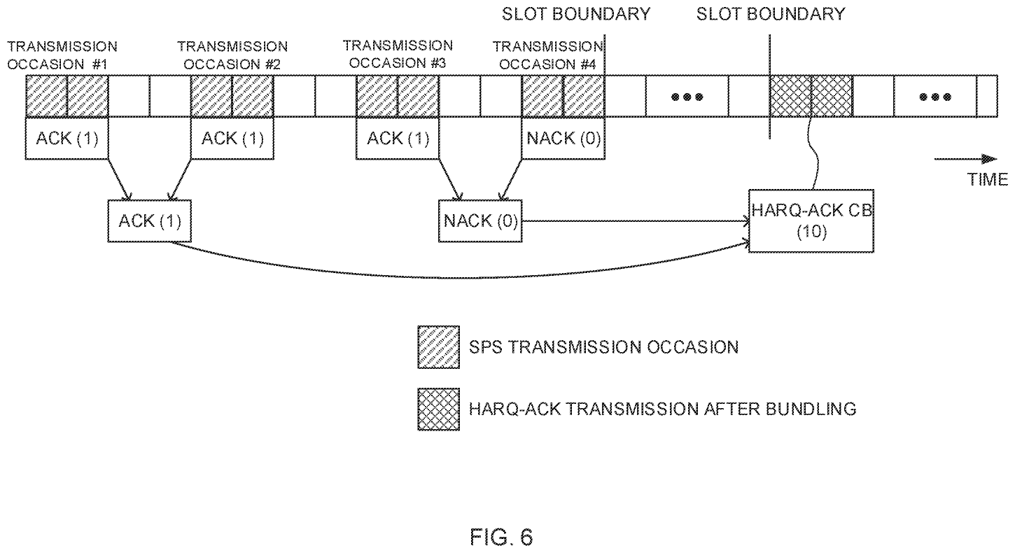

FIG. 6 is a diagram illustrating an example of a HARQ-ACK bundling method for one SPS configuration. In the example illustrated in FIG. 6, transmission occasions #1 to #4 are configured as SPS transmission occasions for the UE. The UE has succeeded in SPS PDSCH reception processing (for example, demodulation and decoding) in the transmission occasions #1, #2, and #3 and has failed in SPS PDSCH reception processing in the transmission occasion #4. The UE transmits a negative acknowledgement response (NACK (first value (for example, 0))) for a transmission occasion (SPS PDSCH) in which the reception processing has failed, and transmits a positive acknowledgement response (ACK (second value (for example, 1))) for a transmission occasion (SPS PDSCH) in which the reception processing has succeeded.

The example of FIG. 6 illustrates a case where N=2 is set as the value of the bundling unit. The UE bundles up to every two HARQ-ACKs in ascending order of transmission occasions. For example, since the HARQ-ACKs of the transmission occasions #1 and #2 are both ACK (1), the HARQ-ACK after bundling is ACK (1). In addition, since the HARQ-ACKs of the transmission occasions #1 and #2 are ACK (1) and NACK (0), respectively, the HARQ-ACK after bundling is NACK (0). The UE arranges the HARQ-ACK codebook (CB) after bundling as 10 in the order of bundling, and transmits the HARQ-ACK CB to the NW.

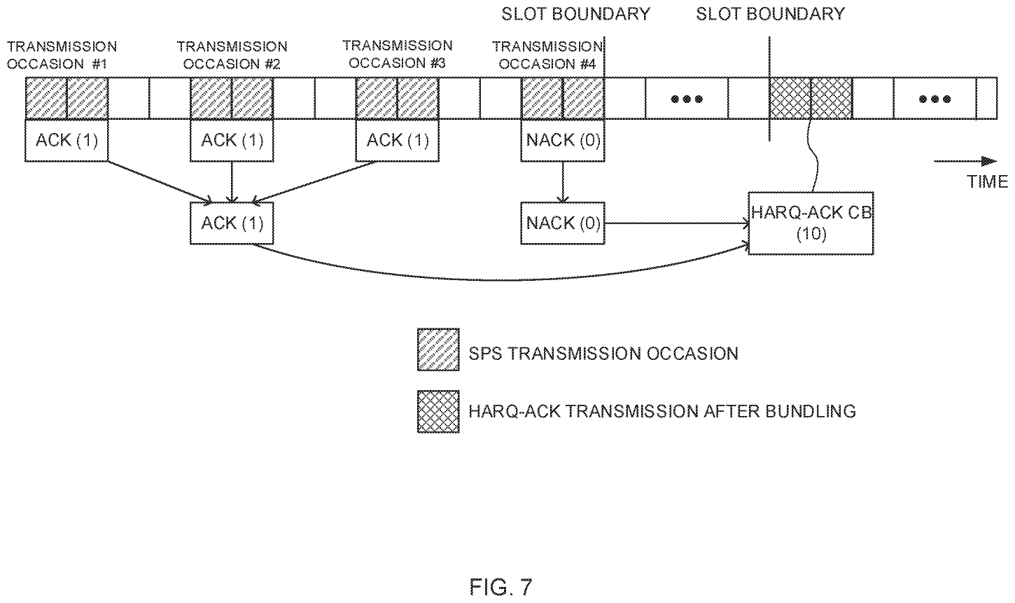

FIG. 7 is a diagram illustrating another example of the HARQ-ACK bundling method for one SPS configuration. The SPS transmission occasion and the configuration of ACK/NACK and the like in FIG. 7 are the same as those in FIG. 6.

The example of FIG. 7 illustrates a case where N=3 is set as the value of the bundling unit. The UE bundles up to every three HARQ-ACKs in ascending order of transmission occasions. For example, the HARQ-ACKs of the transmission occasions #1, #2, and #3 are all ACKs (1), and thus the HARQ-ACK after bundling is ACK (1). The HARQ-ACK of the remaining transmission occasion #4 is NACK (0), and there is no other HARQ-ACK to be bundled. The UE arranges the HARQ-ACK codebook (CB) after bundling as 10 in the order of bundling, and transmits the HARQ-ACK CB to the NW.

### Embodiment 6-2

In Embodiment 6-2, a HARQ-ACK codebook bundling/generation method of the UE in a case where SPS HARQ-ACK bundling is triggered/activated for a plurality of SPS configurations will be described. Embodiment 6-2 is broadly divided into Embodiment 6-2-1 in which, among a plurality of SPS configurations, bundling is applied independently to each SPS configuration, Embodiment 6-2-2 in which bundling is applied in common to a plurality of SPS configurations, and Embodiment 6-2-3 in which bundling is applied for each group (also referred to as a bundling group) including one or more SPS configurations.

The UE may apply bundling independently to each SPS configuration among a plurality of SPS configurations (Embodiment 6-2-1). In other words, the UE may apply bundling separately for each SPS configuration among a plurality of SPSs.

In Embodiment 6-2-1, the UE may perform SPS HARQ-ACK bundling for a certain SPS configuration according to the method described in step 1 of Embodiment 6-1 described above (step 1).

Then, the UE may transmit a HARQ-ACK codebook after bundling to the NW (step 2).

In step 2, the bits of the HARQ-ACKs corresponding to each of the SPS configuration in which bundling is not applied and the SPS configuration in which bundling is applied may be ordered in the same HARQ-ACK codebook in ascending order of information regarding the SPS configuration (for example, the SPS configuration index).

Further, in step 2, the bits of the HARQ-ACKs corresponding to the SPS configuration in which bundling is not applied may be arranged first in ascending order of the information regarding the SPS configuration (for example, the SPS configuration index), and then the bits of the HARQ-ACKs corresponding to the SPS configuration in which bundling is applied may be added.

Alternatively, in step 2, the bits of the HARQ-ACKs corresponding to the SPS configuration in which bundling is applied may be arranged first in ascending order of the information regarding the SPS configuration (for example, the SPS configuration index), and then the bits of the HARQ-ACKs corresponding to the SPS configuration in which bundling is not applied may be added.

Further, the UE may apply bundling to a plurality of SPS configurations in common (Embodiment 6-2-2). In other words, the UE may jointly apply bundling to a plurality of SPS configurations. Note that the plurality of SPS configurations in the present embodiment may mean all active SPS configurations.

The UE may bundle bits of HARQ-ACKs every specific number (for example, N) (step 1). At this time, N may be determined by the method described in the fifth embodiment.

In step 1, SPS transmission occasions for a plurality of SPS configurations to be bundled may be ordered in ascending order of information regarding the SPS configurations (for example, the SPS configuration indexes) (Embodiment 6-2-2-1). Further, in step 1, SPS transmission occasions for a plurality of SPS configurations to be bundled may be ordered in ascending order of start times or end times of the SPS transmission occasions (Embodiment 6-2-2-2).

Then, the UE may transmit a HARQ-ACK codebook after bundling to the NW (step 2).

In step 2, the bits of the HARQ-ACKs corresponding to each of the SPS configuration in which bundling is not applied and the SPS configuration in which bundling is applied may be ordered in the same HARQ-ACK codebook in ascending order of information regarding the SPS configuration (for example, the SPS configuration index) (Embodiment 6-2-2-3).

In Embodiment 6-2-2-3, the UE may assume that SPS configurations in which bundling is not applied are ordered in ascending order of information regarding the SPS configurations (for example, the SPS configuration indexes). Furthermore, in Embodiment 6-2-2-3, the UE may assume that SPS configurations in which bundling is applied are ordered in ascending order of information regarding the lowest/highest SPS configuration (for example, the SPS configuration index) among the SPS configurations in which bundling is applied or information regarding a SPS configuration corresponding to the earliest SPS transmission occasion (for example, the SPS configuration index).

Further, in step 2, the bits of the HARQ-ACKs corresponding to the SPS configuration in which bundling is not applied may be arranged first in ascending order of the information regarding the SPS configuration (for example, the SPS configuration index), and then the bits of the HARQ-ACKs corresponding to the SPS configuration in which bundling is applied may be added.

Alternatively, in step 2, the bits of the HARQ-ACKs corresponding to the SPS configuration in which bundling is applied may be arranged first in ascending order of the information regarding the SPS configuration (for example, the SPS configuration index), and then the bits of the HARQ-ACKs corresponding to the SPS configuration in which bundling is not applied may be added.

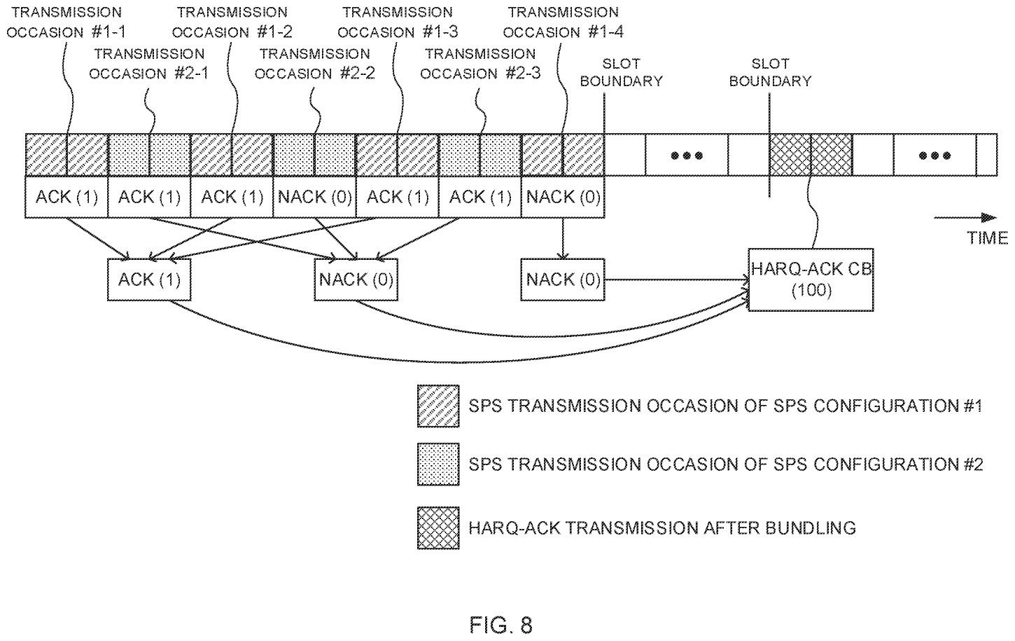

FIG. 8 is a diagram illustrating an example of a HARQ-ACK bundling method for a plurality of SPS configurations. In the example illustrated in FIG. 8, for the UE, transmission occasions #1-1 to #1-4 are configured as SPS transmission occasions of a SPS configuration #1 (for example, corresponding to a SPS configuration index #1), and transmission occasions #2-1 to #2-3 are configured as SPS transmission occasions of a SPS configuration #2 (for example, corresponding to a SPS configuration index #2).

In the example illustrated in FIG. 8, the UE has succeeded in SPS PDSCH reception processing (for example, demodulation and decoding) in the transmission occasions #1-1, #2-1, #1-2, #1-3, and #2-3 and has failed in SPS PDSCH reception processing in the transmission occasions #2-2 and #1-4.

The example of FIG. 8 illustrates a case where N=3 is set as the value of the bundling unit. The UE bundles up to every three HARQ-ACKs in ascending order of transmission occasion separately for each SPS configuration. For example, for the SPS configuration #1, the HARQ-ACKs of the transmission occasions #1-1 to #1-3 are all ACKs (1), and thus the HARQ-ACK after bundling is ACK (1). Further, the HARQ-ACK of the remaining transmission occasion #4 is NACK (0), and there is no other HARQ-ACK to be bundled for the SPS configuration #1. For the SPS configuration #2, the HARQ-ACKs of the transmission occasions #2-1, #2-2, and #2-3 are ACK (1), NACK (0), and ACK (1), respectively, and thus the HARQ-ACK after bundling is NACK (0).

In the example illustrated in FIG. 8, the UE arranges the HARQ-ACK codebook (CB) after bundling as 100 in order from the bit of the earliest start and end time of the SPS transmission occasion, and transmits the HARQ-ACK CB to the NW.

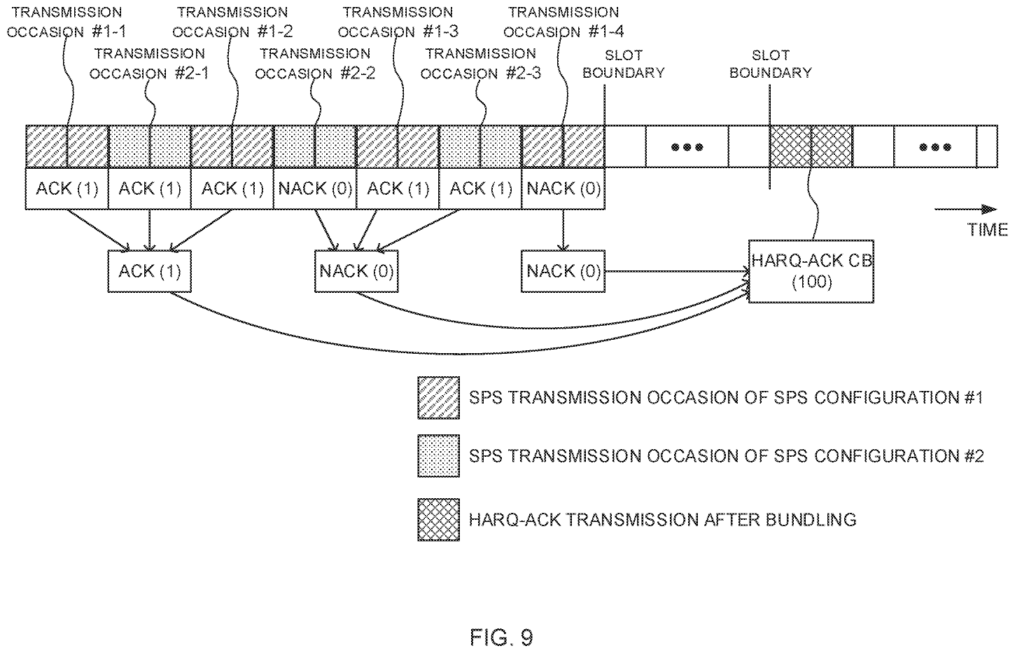

FIG. 9 is a diagram illustrating another example of the HARQ-ACK bundling method for a plurality of SPS configurations. The SPS transmission occasion, the configuration of ACK/NACK, and the number N as the bundling unit in FIG. 9 are the same as those in FIG. 8.

In the example illustrated in FIG. 9, the UE bundles up to every three HARQ-ACKs in ascending order of transmission occasions. The UE bundles up to every three HARQ-ACKs in ascending order of transmission occasions collectively for a plurality of SPS configurations. For example, the HARQ-ACKs of the transmission occasions #1-1, #2-1, and #1-2 are all ACKs (1), and thus the HARQ-ACK after bundling is ACK (1). Next, the HARQ-ACKs of the transmission occasions #2-2, #1-3, and #2-3 are NACK (0), ACK (1), and ACK (1), respectively, and thus the HARQ-ACK after bundling is NACK (0). Further, the HARQ-ACK of the remaining transmission occasion #4 is NACK (0), and there is no other HARQ-ACK to be bundled.

In the example illustrated in FIG. 9, the UE arranges the HARQ-ACK codebook (CB) after bundling as 100 in order from the bit of the earliest start and end time of the SPS transmission occasion, and transmits the HARQ-ACK CB to the NW.

In addition, the UE may apply bundling for each group including one or more SPS configurations (Embodiment 6-2-3). In other words, the UE may apply bundling for each SPS configuration included in the group among the plurality of SPSs.

The group may be referred to as a bundling group, a SPS configuration group, a SPS configuration bundling group, a SPS HARQ-ACK group, a SPS HARQ-ACK bundling group, a unit group, or the like. The UE may receive information regarding which SPS configuration is included in the group from the NW by higher layer signaling.

In Embodiment 6-2-3, “a SPS configuration in which bundling is applied” may mean “a SPS configuration in which bundling is applied in a certain group”.

The UE may perform SPS HARQ-ACK bundling by the method described in Embodiments 6-1/6-2-1/6-2-2 above for one or more SPS configurations included in one group (step 1).

Then, the UE may transmit a HARQ-ACK codebook after bundling to the NW (step 2).

In step 2, the bits of the HARQ-ACKs corresponding to each of the SPS configuration in which bundling is not applied and the SPS configuration in which bundling is applied (a SPS configuration included in a certain group) may be ordered in the same HARQ-ACK codebook in ascending order of information regarding the SPS configuration (for example, the SPS configuration index) (Embodiment 6-2-3-1).

In Embodiment 6-2-3-1, the UE may assume that SPS configurations in which bundling is not applied are ordered in ascending order of information regarding the SPS configurations (for example, the SPS configuration indexes). Furthermore, in Embodiment 6-2-3-1, the UE may assume that SPS configurations in which bundling is applied are ordered in ascending order from information regarding the lowest/highest SPS configuration (for example, the SPS configuration index) among the SPS configurations in which bundling is applied or information regarding a SPS configuration corresponding to the earliest SPS transmission occasion (for example, the SPS configuration index).

Alternatively, in step 2, the bits of the HARQ-ACKs corresponding to the SPS configuration in which bundling is not applied may be arranged first in ascending order of the information regarding the SPS configuration (for example, the SPS configuration index), and then the bits of the HARQ-ACKs corresponding to the SPS configuration in which bundling is applied may be added.

Alternatively, in step 2, the bits of the HARQ-ACKs corresponding to the SPS configuration in which bundling is applied may be arranged first in ascending order of the information regarding the SPS configuration (for example, the SPS configuration index), and then the bits of the HARQ-ACKs corresponding to the SPS configuration in which bundling is not applied may be added.

Alternatively, in step 2, the bits of the HARQ-ACKs corresponding to the SPS configuration in which bundling is not applied may be arranged first in ascending order of the information regarding the SPS configuration (for example, the SPS configuration index). Next, the bits of the HARQ-ACKs to which bundling of a group including one SPS configuration is applied may be arranged in ascending order of the information regarding the SPS configuration (for example, the SPS configuration index). Further, it may be assumed that the bits of the HARQ-ACKs to which bundling of a group including a plurality of SPS configurations is applied are ordered in ascending order from the information regarding the lowest/highest SPS configuration (for example, the SPS configuration index) among the SPS configurations or the information regarding the SPS configuration corresponding to the earliest SPS transmission occasion (for example, the SPS configuration index).

According to the sixth embodiment described above, even in a case where SPS HARQ-ACK bundling is applied to one or more SPS HARQ-ACKs, a HARQ-ACK codebook after bundling can be appropriately generated.

### <Modifications>

UE capability information defined by whether or not the UE can use (support) DCI/RRC signaling for enabling SPS HARQ-ACK bundling may be newly defined.

In a case where the UE reports the UE capability information, the NW may assume that the UE applies the SPS HARQ-ACK bundling described above.

### (Radio Communication System)

Hereinafter, a configuration of a radio communication system according to one embodiment of the present disclosure will be described. In this radio communication system, communication is performed using one or a combination of radio communication methods according to the embodiments of the present disclosure.

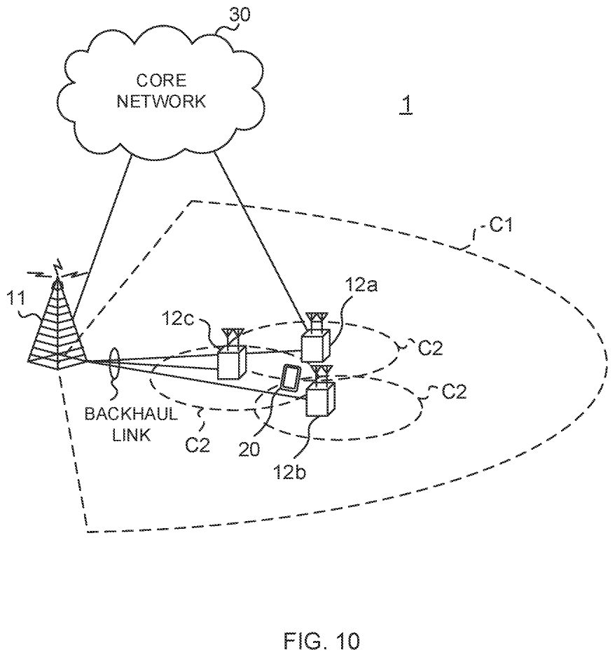

FIG. 10 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)) and dual connectivity between NR and LTE (NR-E-UTRA dual connectivity (NE-DC)).

In the EN-DC, an LTE (E-UTRA) base station (eNB) is a master node (MN), and an NR base station (gNB) is a secondary node (SN). In the NE-DC, an NR base station (gNB) is the MN, and an LTE (E-UTRA) base station (eNB) is the SN.

The radio communication system 1 may support dual connectivity between a plurality of base stations in the same RAT (for example, dual connectivity in which both the MN and the SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are disposed within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as base stations 10 when the base stations 11 and 12 are not distinguished from each other.

The user terminal 20 may be connected to at least one of the plurality of base stations 10. The user terminal 20 may use at least one of carrier aggregation (CA) using a plurality of component carriers (CC) or dual connectivity (DC).

Each CC may be included in a first Frequency Range 1 (FR1) and/or a second Frequency Range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like, of FR1 and FR2 are not limited thereto, and, for example, FR1 may correspond to a frequency range higher than FR2.

Further, the user terminal 20 may perform communication in each CC using at least one of time division duplex (TDD) or frequency division duplex (FDD).

The plurality of base stations (for example, RRHs) 10 may be connected by wire (for example, an optical fiber, an X2 interface, or the like, in compliance with common public radio interface (CPRI)) or wirelessly (for example, NR communication). For example, in a case where NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), or a next generation core (NGC), or the like.

The user terminal 20 may a terminal that corresponds to at least one of communication methods such as LTE, LTE-A, and 5G.

In the radio communication system 1, a radio access scheme based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like, may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH) shared by each user terminal 20, a physical broadcast channel (PBCH), a physical downlink control channel (PDCCH), or the like, may be used.

Further, in the radio communication system 1, as an uplink channel, a physical uplink shared channel (PUSCH) shared by each user terminal 20, a physical uplink control channel (PUCCH), a physical random access channel (PRACH), or the like, may be used.

User data, higher layer control information, and a system information block (SIB), and the like, are transmitted by the PDSCH. The PUSCH may transmit the user data, higher layer control information, and the like. Furthermore, a master information block (MIB) may be transmitted on the PBCH.

Lower layer control information may be transmitted by the PDCCH. The lower layer control information may include, for example, downlink control information (DCI) including scheduling information of at least one of the PDSCH or the PUSCH.

Note that the DCI that schedules the PDSCH may be referred to as DL assignment, DL DCI, or the like, and the DCI that schedules PUSCH may be referred to as UL grant, UL DCI, or the like. Note that the PDSCH may be read as DL data, and the PUSCH may be read as UL data.

For detection of the PDCCH, a control resource set (CORESET) and a search space may be used. The CORESET corresponds to a resource that searches for DCI. The search space corresponds to a search area and a search method for PDCCH candidates. One CORESET may be associated with one or more search spaces. The UE may monitor the CORESET associated with a certain search space on the basis of search space configuration.

One search space may correspond to a PDCCH candidate corresponding to one or more aggregation levels. One or more search spaces may be referred to as a search space set. Note that “search space”, “search space set”, “search space configuration”, “search space set configuration”, “CORESET”, “CORESET configuration”, and the like, in the present disclosure may be read each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), and the like, may be transmitted by the PUCCH. A random access preamble for establishing connection with a cell may be transmitted on the PRACH.

Note that in the present disclosure, downlink, uplink, and the like, may be expressed without “link”. Various channels may also be expressed without adding “physical” in front of the channels.

In the radio communication system 1, a synchronization signal (SS), a downlink reference signal (DL-RS), and the like, may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like, may be transmitted as the DL-RS.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that the SS, the SSB, or the like, may also be referred to as a reference signal.

Further, in the radio communication system 1, a sounding reference signal (SRS), a demodulation reference signal (DMRS), and the like, may be transmitted as an uplink reference signal (UL-RS). Note that, DMRSs may be referred to as “user terminal-specific reference signals (UE-specific Reference Signals)”.

### (Base Station)

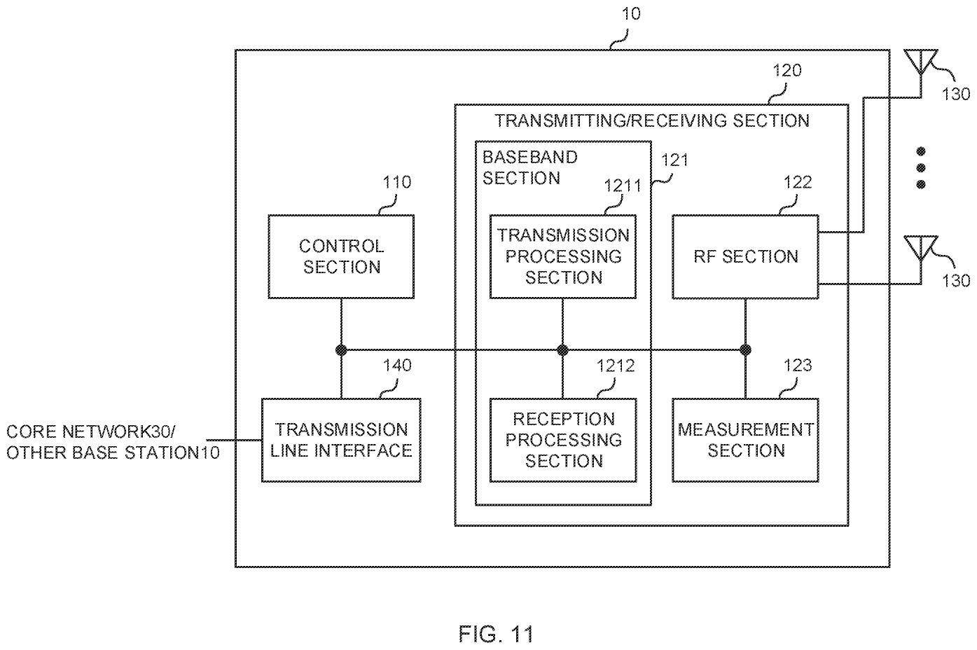

FIG. 11 is a diagram illustrating an example of a configuration of the base station according to one embodiment. The base station 10 includes a control section 110, a transmitting/receiving section 120, a transmitting/receiving antenna 130, and a transmission line interface 140. Note that one or more control sections 110, transmitting/receiving sections 120, transmitting/receiving antennas 130, and transmission line interfaces 140, respectively, may also be provided.

Note that this example mainly describes a functional block which is a characteristic part of the present embodiment, and it may be assumed that the base station 10 also has another functional block necessary for radio communication. Part of processing of each section described below may be omitted.

The control section 110 controls the entire base station 10. The control section 110 can be constituted by a controller, a control circuit, and the like that are described based on common understanding in the technical field according to the present disclosure.

The control section 110 may control signal generation, scheduling (for example, resource allocation or mapping), and the like. The control section 110 may control transmission/reception, measurement, and the like using the transmitting/receiving section 120, the transmitting/receiving antenna 130, and the transmission line interface 140. The control section 110 may generate data to be transmitted as a signal, control information, a sequence, and the like, and may forward the data, the control information, the sequence, and the like to the transmitting/receiving section 120. The control section 110 may perform call processing (such as configuration or releasing) of a communication channel, management of the state of the base station 10, and management of a radio resource.

The transmitting/receiving section 120 may include a baseband section 121, a radio frequency (RF) section 122, and a measurement section 123. The baseband section 121 may include a transmission processing section 1211 and a reception processing section 1212. The transmitting/receiving section 120 can be constituted by a transmitter/receiver, an RF circuit, a baseband circuit, a filter, a phase shifter, a measurement circuit, a transmitting/receiving circuit, and the like, which are described based on common understanding in the technical field pertaining to the present disclosure.

The transmitting/receiving section 120 may be configured as an integrated transmitting/receiving section or may be configured by a transmitting section and a receiving section. The transmitting section may include the transmission processing section 1211 and the RF section 122. The receiving section may be implemented by the reception processing section 1212, the RF section 122, and the measurement section 123.

The transmitting/receiving antenna 130 can be constituted by an antenna, for example, an array antenna or the like, which is described based on common understanding in the technical field according to the present disclosure.

The transmitting/receiving section 120 may transmit the above-described downlink channel, synchronization signal, downlink reference signal, and the like. The transmitting/receiving section 120 may receive the above-described uplink channel, uplink reference signal, and the like.

The transmitting/receiving section 120 may form at least one of a Tx beam and a reception beam by using digital beam forming (for example, precoding), analog beam forming (for example, phase rotation), and the like.

The transmitting/receiving section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, on, for example, data, control information, and the like, acquired from the control section 110, to generate a bit string to be transmitted.

The transmitting/receiving section 120 (transmission processing section 1211) may perform transmission processing such as channel encoding (which may include error correcting coding), modulation, mapping, filtering processing, Discrete Fourier Transform (DFT) processing (if necessary), Inverse Fast Fourier Transform (IFFT) processing, precoding, or digital-analog conversion on the bit string to be transmitted, to output a baseband signal.

The transmitting/receiving section 120 (RF section 122) may perform modulation to a radio frequency band, filtering processing, amplification, and the like, on the base band signal, and may transmit a signal in the radio frequency band via the transmitting/receiving antenna 130.

Meanwhile, the transmitting/receiving section 120 (RF section 122) may perform amplification, filtering processing, demodulation to a base band signal, and the like, on the signal in the radio frequency band received by the transmitting/receiving antenna 130.

The transmitting/receiving section 120 (reception processing section 1212) may apply reception processing such as analog-digital transform, fast fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired base band signal to acquire user data, and the like.

The transmitting/receiving section 120 (measurement section 123) may perform measurement on the received signal. For example, the measurement section 123 may perform radio resource management (RRM), channel state information (CSI) measurement, and the like, on the basis of the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be outputted to the control section 110.

The transmission line interface 140 may transmit/receive a signal (backhaul signaling) to and from an apparatus included in the core network 30, other base stations 10, and the like, and may acquire, transmit, and the like, user data (user plane data), control plane data, and the like, for the user terminal 20.

Note that the transmitting section and the receiving section of the base station 10 in the present disclosure may include at least one of the transmitting/receiving section 120, the transmitting/receiving antenna 130, or the transmission line interface 140.

The transmitting/receiving section 120 may transmit information regarding skipping of a hybrid automatic repeat request acknowledgement (HARQ-ACK) for a semi-persistent scheduling (SPS) physical downlink shared channel (PDSCH) that is not transmitted. The control section 110 may control reception of a HARQ-ACK for a SPS PDSCH that is transmitted, to which HARQ-ACK bundling is to be applied on the basis of the information included in downlink control information (DCI) (first embodiment).

The transmitting/receiving section 120 may transmit first information (for example, a skipping pattern) related to skipping of hybrid automatic repeat request acknowledgement (HARQ-ACK) and second information regarding a HARQ-ACK bundling unit. The control section 110 may control reception of a HARQ-ACK for a SPS PDSCH that is transmitted, to which HARQ-ACK bundling is to be applied on the basis of the first information and the second information (fifth and sixth embodiments).

### (User Terminal)

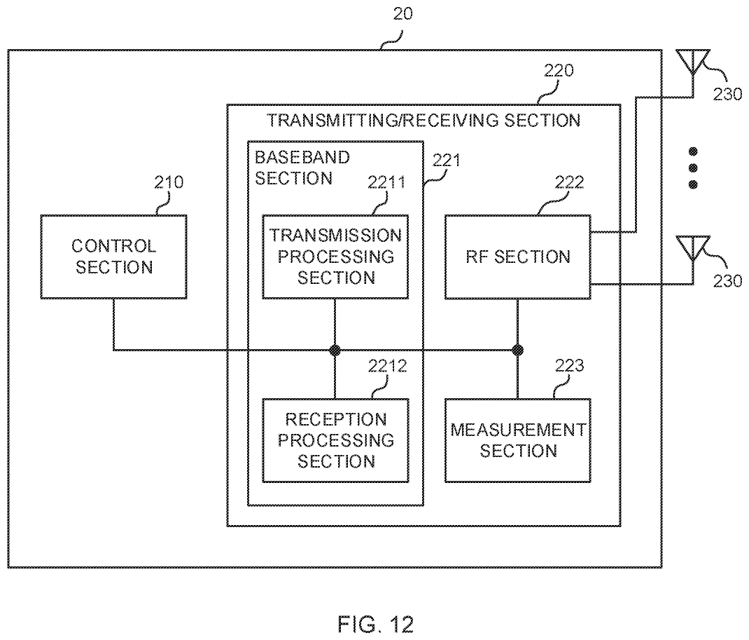

FIG. 12 is a diagram illustrating an example of a configuration of the user terminal according to one embodiment. The user terminal 20 includes a control section 210, a transmitting/receiving section 220, and a transmitting/receiving antenna 230. Note that, one or more each of the control sections 210, the transmitting/receiving sections 220, and the transmitting/receiving antennas 230 may be included.

Note that, although this example mainly describes functional blocks of a characteristic part of the present embodiment, it may be assumed that the user terminal 20 includes other functional blocks that are necessary for radio communication as well. Part of processing of each section described below may be omitted.

The control section 210 controls the entire user terminal 20. The control section 210 can be constituted by a controller, a control circuit, or the like, which is described on the basis of common recognition in the technical field to which the present disclosure relates.

The control section 210 may control signal generation, mapping, and the like. The control section 210 may control transmission/reception, measurement, and the like, using the transmitting/receiving section 220 and the transmitting/receiving antenna 230. The control section 210 may generate data to be transmitted as a signal, control information, a sequence, and the like, and may transfer the data, the control information, the sequence, and the like, to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can include a transmitter/receiver, an RF circuit, a baseband circuit, a filter, a phase shifter, a measurement circuit, a transmitting/receiving circuit, and the like that are described on the basis of common recognition in the technical field related to the present disclosure.

The transmitting/receiving section 220 may be formed as an integrated transmitting/receiving section, or may include a transmitting section and a receiving section. The transmitting section may be constituted by the transmission processing section 2211 and the RF section 222. The receiving section may include the reception processing section 2212, the RF section 222, and the measurement section 223.

The transmitting/receiving antenna 230 can include an antenna described on the basis of common recognition in the technical field related to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a Tx beam and a reception beam by using digital beam forming (for example, precoding), analog beam forming (for example, phase rotation), and the like.

The transmitting/receiving section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmitting/receiving section 220 (transmission processing section 2211) may perform transmission processing such as channel encoding (which may include error correcting coding), modulation, mapping, filtering processing, DFT processing (if necessary), IFFT processing, precoding, or digital-analog transform on a bit string to be transmitted, and may output a baseband signal.

Note that whether or not to apply DFT processing may be determined on the basis of configuration of transform precoding. In a case where transform precoding is enabled for a channel (for example, PUSCH), the transmitting/receiving section 220 (transmission processing section 2211) may perform DFT processing as the transmission processing in order to transmit the channel using a DFT-s-OFDM waveform. In a case where transform precoding is not enabled for a channel (for example, PUSCH), the transmitting/receiving section 220 (transmission processing section 2211) does not have to perform DFT processing as the transmission processing.

The transmitting/receiving section 220 (RF section 222) may perform modulation to a radio frequency band, filtering processing, amplification, and the like, on the baseband signal and may transmit a signal in the radio frequency band via the transmitting/receiving antenna 230.

Meanwhile, the transmitting/receiving section 220 (RF section 222) may perform amplification, filtering processing, demodulation to a baseband signal, and the like, on the signal in the radio frequency band received by the transmitting/receiving antenna 230.

The transmitting/receiving section 220 (reception processing section 2212) may acquire user data, and the like, by applying reception processing such as analog-digital transform, FFT processing, IDFT processing (if necessary), filtering processing, demapping, demodulation, decoding (which may include error correction decoding), MAC layer processing, RLC layer processing, or PDCP layer processing on the acquired baseband signal.

The transmitting/receiving section 220 (measurement section 223) may perform measurement on the received signal. For example, the measurement section 223 may perform RRM measurement, CSI measurement, and the like, on the basis of the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmitting section and the receiving section of the user terminal 20 in the present disclosure may be constituted by at least one of the transmitting/receiving section 220 or the transmitting/receiving antenna 230.

The transmitting/receiving section 220 may receive information regarding skipping of a hybrid automatic repeat request acknowledgement (HARQ-ACK) for a semi-persistent scheduling (SPS) physical downlink shared channel (PDSCH) that is not transmitted. The control section 210 may control HARQ-ACK bundling for a SPS PDSCH that is transmitted, on the basis of the information included in downlink control information (DCI) (first embodiment).

The control section 210 may control a period in which the bundling is applied on the basis of at least one of DCI for releasing a SPS PDSCH, a configured SPS configuration, or higher layer signaling (second embodiment).

The control section 210 may determine a HARQ-ACK to which the bundling is to be applied on the basis of at least one of a reception timing of the DCI or a transmission timing of the HARQ-ACK for the DCI (third embodiment).

The control section 210 may determine one or more SPS configurations in which the bundling is to be applied on the basis of at least one of the DCI or higher layer signaling (fourth embodiment).

The transmitting/receiving section 220 may transmit the first information related to skipping of a hybrid automatic repeat request acknowledgement (HARQ-ACK) and the second information regarding a HARQ-ACK bundling unit. The control section 210 may control, on the basis of the first information, skipping of a HARQ-ACK for a semi-persistent scheduling (SPS) physical downlink shared channel (PDSCH) that is not transmitted, and apply HARQ-ACK bundling to a HARQ-ACK for a SPS PDSCH that is transmitted, on the basis of the second information (fifth and sixth embodiments).

The control section 210 may apply, to one SPS configuration, HARQ-ACK bundling in ascending order of at least one of a SPS transmission occasion or a SPS configuration index (sixth embodiment).

The control section 210 may apply HARQ-ACK bundling to a plurality of SPS configurations separately for each SPS configuration or in ascending order of at least one of a SPS transmission occasion or a SPS configuration index in common for a plurality of SPS configurations (sixth embodiment).

The control section 210 may apply HARQ-ACK bundling in ascending order of at least one of a SPS transmission occasion or a SPS configuration index for each group including one or more SPS configurations (sixth embodiment).

### (Hardware Configuration)

Note that the block diagrams that have been used to describe the above embodiments illustrate blocks in functional units. These functional blocks (components) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be implemented by combining the one apparatus or the plurality of apparatuses with software.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmitting section (transmitting unit), a transmitter, and the like. In any case, as described above, the implementation method is not particularly limited.

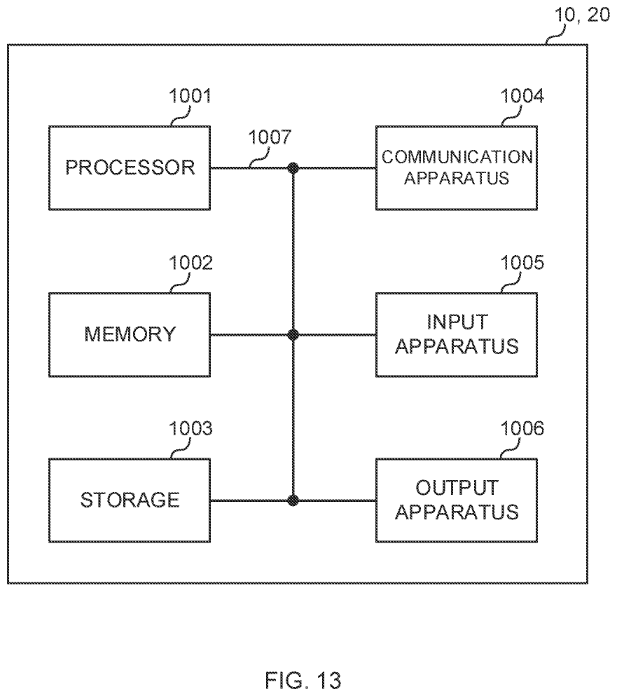

For example, the base station, the user terminal, and the like according to one embodiment of the present disclosure may function as a computer that executes the processing of the radio communication method of the present disclosure. FIG. 13 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that, in the present disclosure, terms such as apparatus, circuit, device, section, or unit are interchangeable. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be provided. Further, the processing may be executed by one processor, or the processing may be executed by two or more processors simultaneously or sequentially, or using other methods. Note that the processor 1001 may be implemented by one or more chips.

Each function of the base station 10 and the user terminal 20 is implemented by predetermined software (program) being read on hardware such as the processor 1001 and the memory 1002, by which the processor 1001 performs operations, controlling communication via the communication apparatus 1004, and controlling at least one of reading or writing of data from/to the memory 1002 and the storage 1003.

The processor 1001 controls the whole computer by, for example, running an operating system. The processor 1001 may be implemented by a central processing unit (CPU) including an interface with peripheral equipment, a control apparatus, an operation apparatus, a register, and the like. For example, at least part of the above-described control section 110 (210), transmitting/receiving section 120 (220), and the like may be implemented by the processor 1001.

The processor 1001 reads programs (program codes), software modules, data, etc. from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by a control program that is stored in the memory 1002 and that operates in the processor 1001, and other functional blocks may be similarly implemented.

The memory 1002 is a computer-readable recording medium, and may be constituted by, for example, at least one of a Read Only Memory (ROM), an Erasable Programmable ROM (EPROM), an Electrically EPROM (EEPROM), a Random Access Memory (RAM), or other appropriate storage media. The memory 1002 may be referred to as a register, a cache, a main memory (primary storage apparatus), and the like. The memory 1002 can store programs (program codes), software modules, etc. that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM), and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as secondary storage apparatus.

The communication apparatus 1004 is hardware (transmitting/receiving device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmitting/receiving section 120 (220), the transmitting/receiving antenna 130 (230), and the like described above may be implemented by the communication apparatus 1004. The transmitting/receiving section 120 (220) may be implemented by being physically or logically separated into the transmitting section 120a (220a) and the receiving section 120b (220b).

The input apparatus 1005 is an input device for receiving input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, or the like). It is noted that the input apparatus 1005 and the output apparatus 1006 may be provided in an integrated structure (for example, a touch panel).

Furthermore, these pieces of apparatus, including the processor 1001, the memory 1002 and so on are connected to each other by the bus 1007 so as to communicate information. The bus 1007 may be constituted using a single bus, or may be constituted by buses that vary between apparatuses.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented by using at least one of these pieces of hardware.

### (Modifications)

Note that terms described in the present disclosure and terms necessary for understanding the present disclosure may be replaced with terms that have the same or similar meanings. For example, a channel, a symbol, and a signal (signal or signaling) may be replaced with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may be constituted with one or more periods (frames) in a time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for transmission and/or reception of a certain signal or channel. For example, the numerology may indicate at least one of subcarrier spacing (SCS), a bandwidth, a symbol length, a cyclic prefix length, a Transmission Time Interval (TTI), the number of symbols per TTI, a radio frame configuration, specific filter processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Further, a slot may be a time unit based on numerology.

A slot may include a plurality of mini slots. Each mini slot may include one or more symbols in the time domain. Further, the mini slot may be referred to as a sub-slot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) to be transmitted using a mini slot may be referred to as “PDSCH (PUSCH) mapping type B”.

A radio frame, a subframe, a slot, a mini slot and a symbol all represent the time unit in signal communication. The radio frame, the subframe, the slot, the mini slot, and the symbol may be called by other applicable names, respectively. Note that time units such as frame, subframe, slot, mini slot, and symbol in the present disclosure are interchangeable.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot” and so on, instead of a “subframe.”

Here, a TTI refers to, for example, the minimum time unit of scheduling in radio communication. For example, in the LTE system, a base station performs scheduling to allocate radio resources (a frequency bandwidth, transmission power, and the like that can be used in each user terminal) to each user terminal in TTI units. Note that the definition of TTI is not limited to this.

The TTI may be a transmission time unit of a channel-coded data packet (transport block), a code block, a codeword, and the like, or may be a processing unit of scheduling, link adaptation, and so on. When the TTI is given, a time interval (e.g., the number of symbols) to which a transport block, a code block, a codeword, or the like, is actually mapped may be shorter than the TTI.

Note that, when one slot or one mini slot is referred to as a “TTI,” one or more TTIs (that is, one or more slots or one or more mini slots) may be the minimum time unit of scheduling. Also, the number of slots (the number of mini slots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than a usual TTI may be referred to as a shortened TTI, a short TTI, a partial TTI (a partial TTI or a fractional TTI), a shortened subframe, a short subframe, a mini slot, a sub-slot, a slot, and so on.

Note that a long TTI (for example, a usual TTI, a subframe, and the like) may be replaced with a TTI having a time duration exceeding 1 ms, and a short TTI (for example, a shortened TTI) may be replaced with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

Also, an RB may include one or more symbols in the time domain, and may be one slot, one mini slot, one subframe or one TTI in length. One TTI, one subframe, etc. may each be constituted with one or more resource blocks.

Note that one or more RBs may be referred to as a Physical Resource Block (PRB), a Sub-Carrier Group (SCG), a Resource Element Group (REG), a PRB pair, an RB pair, and so on.

Furthermore, a resource block may be constituted by one or more Resource Elements (REs). For example, one RE may be a radio resource domain of one subcarrier and one symbol.

A bandwidth part (BWP) (which may be referred to as a partial bandwidth, or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a UL BWP (BWP for UL) and a DL BWP (BWP for DL). For the UE, one or more BWPs may be configured within one carrier.

At least one of the configured BWPs may be active, and it need not be assumed that the UE transmits/receives a predetermined signal/channel outside the active BWP. Note that “cell”, “carrier”, etc. in the present disclosure may be replaced with “BWP”.

Note that the structures of radio frames, subframes, slots, mini slots, symbols and so on described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, etc. described in the present disclosure may be represented using absolute values, or may be represented using relative values with respect to predetermined values, or may be represented using other corresponding information. For example, a radio resource may be indicated by a predetermined index.

The names used for parameters and so on in the present disclosure are in no respect limiting. Further, any mathematical expression or the like that uses these parameters may differ from those explicitly disclosed in the present disclosure. Because various channels (PUCCH, PDCCH, and the like) and information elements can be identified by any suitable names, various names allocated to these various channels and information elements are not restrictive names in any respect.

The information, signals, etc. described in the present disclosure may be represented using any of a variety of different technologies. For example, data, instructions, commands, information, signals, bits, symbols and chips, all of which may be referenced throughout the above description, may be represented by voltages, currents, electromagnetic waves, magnetic fields or particles, optical fields or photons, or any combination of these.

Information, signals, etc. can be output in at least one of a direction from a higher layer to a lower layer or a direction from a lower layer to a higher layer. Information, signals, and the like may be input and output via a plurality of network nodes.

The information, signals and so on that are input and/or output may be stored in a specific location (for example, in a memory), or may be managed in a management table. The information, signals, and the like to be input and output can be overwritten, updated, or appended. The output information, signals, and the like, may be deleted. The information, signals and so on that are input may be transmitted to other apparatuses.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and so on. Further, the RRC signaling may be referred to as an RRC message, and may be, for example, an RRC Connection Setup message, an RRC Connection Reconfiguration message, and so on. Further, notification of the MAC signaling may be performed using, for example, an MAC control element (CE).

Additionally, reporting of predetermined information (for example, reporting of information to the effect that “X holds”) does not necessarily have to be sent explicitly, and can be sent implicitly (for example, by not reporting this piece of predetermined information, by reporting another piece of information, and so on).

judgments may be made in values represented by one bit (0 or 1), may be made in Boolean values that represent true or false, or may be made by comparing numerical values (for example, comparison against a predetermined value).

Software, whether referred to as “software”, “firmware”, “middleware”, “microcode”, or “hardware description language”, or called by other names, should be interpreted broadly, to mean instructions, instruction sets, codes, code segments, program codes, programs, subprograms, software modules, applications, software applications, software packages, routines, subroutines, objects, executable files, execution threads, procedures, functions, and the like.

Furthermore, software, commands, information and so on may be transmitted and received via transmission media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “Quasi-Co-Location (QCL)”, “Transmission Configuration Indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” may be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station is sometimes referred to using terms such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of the base station and/or the base station subsystem that performs a communication service in this coverage.

As used in the present disclosure, the terms such as “mobile station (MS)”, “user terminal”, “user equipment (UE)”, and “terminal” may be used interchangeably.

The mobile station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable term.

At least one of the base station or the mobile station may be called as a transmission device, a reception device, a radio communication device, and the like. Note that at least one of the base station or the mobile station may be a device mounted on a moving body, a moving body itself, and the like. The moving body may be a transportation (for example, a car, an airplane, or the like), an unmanned moving body (for example, a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, base station in the present disclosure is interchangeable with user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be replaced with terms corresponding to communication between terminals (for example, “side”). For example, an uplink channel and a downlink channel may be read as a side channel.

Likewise, the user terminals in the present disclosure may be interpreted as base stations. In this case, the base stations 10 may have the functions of the user terminals 20 described above.

In the present disclosure, an operation performed by the base station may also be performed by an upper node thereof in some cases. In a network including one or more network nodes with base stations, it is clear that various kinds of operation performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, although various methods have been described in the present disclosure with various components of steps using exemplary orders, the specific orders that are described herein are by no means limiting.

Each aspect/embodiment described in the present disclosure may be applied to a system using Long-Term Evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (xG(x is, for example, an integer or decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded on the basis of the foregoing, and the like. Further, a plurality of systems may be combined (for example, a combination of LTE or LTE-A and 5G, and the like) and applied.

The phrase “based on” as used in the present disclosure does not mean “based only on”, unless otherwise specified. In other words, the phrase “based on” means both “based only on” and “based at least on”.

All references to the elements using designations such as “first” and “second” as used in the present disclosure do not generally limit the amount or sequence of these elements. These designations can be used in the present disclosure, as a convenient way of distinguishing between two or more elements. Thus, references to first and second elements do not mean that only the two elements can be employed, or that the first element must precede the second element in some form.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

In addition, “determining” may be regarded as “determining” receiving (for example, receiving information), transmitting (for example, transmitting information), inputting, outputting, accessing (for example, accessing data in memory), and the like.

In addition, “determining may be regarded as “determining” resolving, selecting, choosing, establishing, comparing, and the like. In other words, “determining” may be regarded as “determining” some action.

In addition, “determining” may be replaced with “assuming”, “expecting”, “considering”, or the like.

The terms “connected” and “coupled” used in the present disclosure, or any variation of these terms mean all direct or indirect connection or coupling between two or more elements and may include presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or the like.

In the present disclosure, the phrase “A and B are different” may mean “A and B are different from each other”. Note that the phrase may mean that “A and B are different from C”. The terms such as “separate”, “coupled”, and the like may be interpreted similarly to “different”.

When “include”, “including”, and variations of these are used in the present disclosure, these terms are intended to be inclusive similarly to the term “comprising”. Moreover, the term “or” used in the present disclosure is intended to be not an exclusive-OR.

In the present disclosure, when articles are added by translation, for example, as “a”, “an”, and “the” in English, the present disclosure may include that nouns that follow these articles are plural.

In the above, the invention according to the present disclosure has been described in detail; however, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

1. A terminal comprising:
a receiving section configured to receive information regarding skipping of a hybrid automatic repeat request acknowledgement (HARQ-ACK) for a semi-persistent scheduling (SPS) physical downlink shared channel (PDSCH) that is not transmitted; and
a control section configured to control HARQ-ACK bundling for a SPS PDSCH that is transmitted, on the basis of information included in downlink control information (DCI).

2. The terminal according to claim 1, wherein the control section controls a period in which the bundling is applied on the basis of at least one of DCI for releasing a SPS PDSCH, a configured SPS configuration, or higher layer signaling.

3. The terminal according to claim 1, wherein the control section determines a HARQ-ACK to which the bundling is to be applied on the basis of at least one of a reception timing of the DCI or a transmission timing of a HARQ-ACK for the DCI.

4. The terminal according to claim 1, wherein the control section determines one or more SPS configurations in which the bundling is to be applied on the basis of at least one of the DCI or higher layer signaling.

5. A radio communication method for a terminal, the radio communication method comprising:
receiving information regarding skipping of a hybrid automatic repeat request acknowledgement (HARQ-ACK) for a semi-persistent scheduling (SPS) physical downlink shared channel (PDSCH) that is not transmitted; and
controlling HARQ-ACK bundling for a SPS PDSCH that is transmitted, on the basis of information included in downlink control information (DCI).

6. A base station comprising:
a transmitting section configured to transmit information regarding skipping of a hybrid automatic repeat request acknowledgement (HARQ-ACK) for a semi-persistent scheduling (SPS) physical downlink shared channel (PDSCH) that is not transmitted; and
a control section configured to control reception of a HARQ-ACK for a SPS PDSCH that is transmitted, to which HARQ-ACK bundling is to be applied, on the basis of information included in downlink control information (DCI).
